(19) United States
(12) Patent Application Publication
(10) Pub. No.: US 2010/0027118 A1
(43) Pub. Date: Feb. 4, 2010

(54) Method and device for modification of surface properties of materials

(75) Inventors: Gil Rosenman, Rishon Le-Zion (IL); Daniel Aronov, Kfar Yona (IL); Jurijs Dehtjars, Riga (LV)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Ramot at Tel-Aviv University Ltd., Tel-Aviv (IL)

(21) Appl. No.: 12/148,824

(22) Filed: Apr. 23, 2008

Related U.S. Application Data
(63) Continuation-in-part of application No. PCT/IL06/01231, filed on Oct. 26, 2006.
(60) Provisional application No. 60/730,021, filed on Oct. 26, 2005.

(51) Int. Cl. G02B 3/00; B01J 19/12; C40B 50/14; C40B 60/14; C40B 40/00

(52) U.S. Cl. 359/507; 250/492.3; 506/30; 506/40; 506/13; 977/773

(57) ABSTRACT

A method and device are presented for modifying parameters of a solid material. This is implemented by applying radiation, such as photon flux and/or charged particle beam and/or heat, to at least a region of the material, and controlling at least one parameter of the applied radiation, thereby modifying a wettability property of the material within the irradiated region(s) thereof in a reversible manner.

### CROSS-REFERENCE TO RELATED APPLICATIONS

This present application is a continuation-in-part of International Application No. PCT/L2006/001231, which was filed on Oct. 26, 2006, published in English, which claims the benefit of U.S. Provisional Patent Application 60/730,021, filed on Oct. 26, 2005. The disclosures of said applications are incorporated by reference herein.

### FIELD OF THE INVENTION

This invention relates to a method and a device for modification of surface properties of a material.

### BACKGROUND OF THE INVENTION

Hydrophilicity is a characteristic of materials exhibiting an affinity for water. These materials when wetted form a water film or coating on their surface. Hydrophilic materials demonstrate a low contact angle value (the angle between water drop and solid state surfaces (FIG. 1). Hydrophobic materials on the other hand, possess the opposite response to water. Hydrophobic materials have little or no tendency to adsorb water and water tends to “bead” on their surfaces (i.e., discrete droplets). Hydrophobic materials possess high contact angle values.

Wettability is a surface property characteristic for all materials, which is unique for each material. The wettability may be determined by one of many methods known to a person skilled in the art, such as liquid droplet contact angle measurements, the captive bubble method, or by complete surface energy analysis. Contact angle is an important macroscopic characteristic of the surface wettability and the interfacial free energy. There are several techniques available for contact angle measurements. The pendent and sessile drop methods are among the most generally used experimental techniques. When a drop of liquid is deposited on the surface of a dense material, the spreading of this drop depends mainly on the surface chemistry as well as on surface topography. At equilibrium, the drop exhibits a spherical shape as shown in FIG. 1; the angle between the solid surface and the tangent to the liquid in contact with the solid is known as the contact angle θ. The contact angle is related to interfacial energies (α) between the different phases by the Young equation (Eq. 1):

αₛᵥ=αₛₗ+αₗᵥ cos θ (Eq. 1)

where subscripts ‘s’, ‘l’ and ‘v’ refer to solid, liquid and vapor, respectively. The only parameters that can be directly measured are θ and αₗᵥ. Thus, to directly determine the two solid surface tensions αₛₗ and αₛᵥ, individually, an additional equation is required. Many controversial approaches are reported in the literature to evaluate solid surface tension. Owen and Wendt's approach (Owens D. K, Wendt R. D. J. Appl. Polym. Sci. 13, 1741 (1969)) is based on the assumption that the total surface tension can be expressed as a sum of two components, α^{p} and α^{d}, which arise owing to a specific type of intermolecular force, polar (α^{p}) and disperse (α^{d}) components, respectively. The dispersive component is defined as twice the geometric mean of the dispersive components of the surface energy of solid and liquid, and can be calculated from Eq. 2:

αₛₗ=αₛᵥ+αₗᵥ−2\sqrt{αₛᵥ^{p}αₛₗ^{p}}−2\sqrt{αₛᵥ^{d}αₛₗ^{d}} (Eq. 2)

From the Eq. 1 and 2, αₛₗ and αₛᵥ can be determined using experimental values of contact angles measured with a pair of testing liquids of known dispersive and polar surface tension components. The work of adhesion (W) is the energy required to separate to infinity the materials in contact, then defined by the Young-Dupré's equation, in the case of a solid/liquid (sl) interface, as:

W=αₛ+αₗ−αₛₗ=αₗᵥ(1+cos θ) (Eq. 3)

where subscripts ‘s’ and ‘l’ refer to solid and liquid respectively.

In another case, when the surface electric potential of the solid/liquid interface is modified, αₗᵥ and αₛᵥ are assumed to be independent of the electric potential modification and remain constant; αₛₗ has contributions from an electrical component (αₛₗ^{el}) and from a chemical (potential-independent) component (αₛₗ⁰) according to the Lippmann equation Eq. 4:

$${α}_{sl} = {α}_{sl}^{0} + {α}_{sl}^{el} = {α}_{sl}^{0} - {\int }_{{ϕ}_{sl}^{0}}^{{ϕ}_{sl}} {σ}_{sl} d {ϕ}_{sl} \qquad ( Eq . 4 )$$

where φₛₗ⁰ is the potential of zero charge, φₛₗ is the potential on the solid/liquid interface, σₛₗ is the surface charge density. The surface charge density σₛₗ is defined by Eq. 5:

$${σ}_{sl} = {\int }_{{ϕ}_{sl}^{0}}^{{ϕ}_{sl}} {C}_{sl} d {ϕ}_{sl} \qquad ( Eq . 5 )$$

Here, Cₛₗ is the differential capacitance of the solid/liquid interface, i.e., when the electric potential difference is presented between the solid and the liquid phase, opposite charges build up on both sides of the interface. Combination of the Eq. 1, 4 and 5 yields the relationship shown in Eq. 6:

$$cos θ = cos {θ}^{0} + \frac{1}{{α}_{lv}} {\int }_{{ϕ}_{sl}^{0}}^{{ϕ}_{sl}} {C}_{sl} d {ϕ}_{sl}^{2} \qquad ( Eq . 6 )$$

where cos θ⁰ is the cosine of the contact angle in the absence of charges. Assuming Cₛₗ to be independent of potential and performing double integration with respect to φₛₗ, enables a relationship between the contact angle and the potential to be established:

$$cos θ = cos {θ}^{0} + \frac{{{C}_{sl} ( {ϕ}_{sl} - {ϕ}_{sl}^{0} )}^{2}}{2 {α}_{lv}} \qquad ( Eq . 7 )$$

At sufficiently high potentials cos θ will become 1, indicating complete wetting (θ=0). The capacitance of the material influences the change in contact angle via dielectric constant and thickness. In the case of a parallel planar discs capacitor with finite thickness:

$${C}_{sl} = \frac{{ɛ}_{0} {ɛ}_{r}}{R - \sqrt{{R}^{2} + {t}^{2}} + t} \qquad ( Eq . 8 )$$

where εᵣ is the dielectric permittivity of the material, r is the material radius and t is its thickness.

Supposing t<<r, enables to simplify Eq. 8 as shown in Eq. 9:

$${C}_{sl} = \frac{{ɛ}_{0} {ɛ}_{r}}{t} \qquad ( Eq . 9 )$$

A more elaborate derivation in presence of electric charges on the surface is given by Digilov (Langmuir, 16, 6719 (2000)).

$$cos {θ}_{q} = cos {θ}^{0} + \frac{{χ}_{slv} {E}_{slv}}{{α}_{lv}} \qquad ( Eq . 10 )$$

where cos θ_{q} is the cosine of the contact angle in the presence of charges, χslv is the line density of the electric charges and Eₛₗᵥ is the strength of the electrostatic field at the wetting line. The line density, χslv, and the strength of the electric field, Eₛₗᵥ, are defined as:

$$\begin{matrix}{χ}_{slv} = {n}_{slv} q & ( Eq . 11 ) \\ {E}_{slv} = \frac{\partial {ϕ}_{slv}}{\partial r} & ( Eq . 12 )\end{matrix}$$

Here, nₛₗᵥ is the line density of the particles at the contact line; q is the electronic charge; ∂φₛₗᵥ is the change of electrostatic potential on the contact line and ∂r is the virtual displacement of the contact line along solid/liquid interface (FIG. 2). At sufficiently high electric charges on the material surface cos θ_{q} will become 1, indicating complete wetting (θ_{q}=0).

The considered basics of interaction of solid state surface with liquid show that many factors of different physical origin influence the surface wettability due to changes of a surface energy of the material and interaction of liquid-substrate.

Strategies for substrates that can be turned on based on electrochemical transformations of self-assembled monolayers (SAM) are also known. The electrochemical reactions alter the physicochemical properties of the surface or change the biological activities of discrete ligands. For example, applied electrical potentials have been used in combination with SAMs of alkanethiolates on gold to alter the wettability of a surface, which was recorded by measurements of the contact angle (N. Abbott, C. Gorman, G. Whitesides, Langmuir 11, 16 (1995)). Reversible switching of the contact angle was caused by electrochemically driven translocation of molecular shuttles. For this purpose, a rotaxane monolayer consisting of the cyclophane cyclobis (paraquat-p-phenylene) threaded on a diiminobenzene unit was self-assembled onto a gold electrode. The contact angle of the system reversibly changed from 55° when the cyclophane was in its oxidized state to 105° for the reduced cyclophane.

Several approaches have also been developed based on light as the trigger of dynamic changes in surface properties, all of which directed to chemical modification of the surface. Chemical systems that undergo changes in wettability upon illumination with light include azobenzene, pyrimidine, O-carboxymethylated calyx, resorcinarene, and spiropyran. Also known is the asymmetric irradiation of photoisomerizable SAMs containing photochromic azobenzene units to create gradients in surface free energy. These surface gradients caused directional motion of water droplets on the substrate. The Ichimura and Nakagawa (Science, 288, 1624 (2000)) were able to tune the direction and the velocity of a droplet by varying the direction and steepness of the light intensity gradient.

Polymers and polypeptides undergo conformational reorientations when changed from one solvent to another or due to a temperature change, because of phase transitions between a well-solvated and a poor solvated state. For instance, a slight temperature change can induce a bulk transition in a perfluorinated polymer from a highly ordered smectic to an isotropic phase. The temperature controllable transition alters both the tackiness of the polymer and the dewetting dynamics of a liquid on the polymer surface (J. Lahann, R. Langer, MRS Bulletin, 30, 1853 (2005)). Matthews et al. (J. Am. Chem. Soc., 125, 6428 (2003)) used monolayers of silanes (on silica) and alkanethiolates (on gold) to create surfaces that switched from a cationic to an anionic state when the pH was changed from 3 to 5. One of the major challenges of temperature-induced switching is the localized application of temperature gradients. Recent advances in microfabrication have enabled the use of miniaturized components, such as microheaters, in combination with temperature-switching surfaces.

A microfluidic device has been developed that can adsorb proteins from solution, hold them with negligible denaturation, and release them on command (FIG. 3). The active element in the device is a 4-nanometer-thick polymer film that can be thermally switched between an antifouling hydrophilic state and a protein-adsorbing state that is more hydrophobic. This active polymer has been integrated into a microfluidic hot plate that can be programmed to adsorb and desorb protein monolayers (D. Huber, R. Manginell, M. Samara, B. Kim, B. Bunker, Science, 301, 352 (2003)).

An alternative approach for dynamically controlling interfacial properties uses an active stimulus (an electrical potential) to trigger specific conformational transitions (e.g., switching from an all-trans to a partially gauche oriented conformation (J. Lahann, R. Langer, MRS Bulletin, 30, 1853 (2005)). Upon application of an electrical potential, the negatively charged carboxylate groups experienced an attractive force to the gold surface, causing the hydrophobic chains to undergo conformational changes (FIG. 4).

Wang et al. (Chem. Commun., 9, 1542 (2003)) reported the electrochemical switching of the hydrophilic/hydrophobic properties of a gold electrode functionalized with a monolayer consisting of bipyridinium units tethered to the electrode surface by long chain thiols (FIG. 5). The bipyridinium dications are repelled from the positively charged electrode surface and the interface is hydrophilic, whereas the reduced bipyridinium radical cations are attracted to the negatively charged electrode surface. The conformational rearrangement results in the exposure of the hydrocarbon spacer chains to the solution and yields a hydrophobic interface.

Hydroxyapatite (HAP) Ca₁₀(PO₄)₆(OH)₂ is the main inorganic constituent of natural bone. HAP ceramics have been highlighted over the past three decades as implantable materials substituting for bone defects, because of the crystal structural and compositional analogousness with the hard tissues of vertebrates. HAP is a potential candidate for drug delivery system because of its biocompatibility and chemical reactivity to various biomaterials. Chemically treated HAP was also used for bacteria adhesion.

Recent advances in materials research have expanded HAP utilization among others, liquid chromatographic columns for the separation of proteins and nucleic acids, as well as catalysts for the dehydration or dehydrogenation of some alcohols, migration barriers for radioactive waste disposal in deep geological sites, and chemical gas sensors. The biomedical significance of HAP is its bioactivity such that HAP ceramics conduct the formation of new bone on their surface. Bone conductivity is inherent in HAP and is ascribed to the characteristic surface structure of HAP, while the detailed mechanism of its bioactivity is still unknown.

Man-made HAP possesses crystallographic similarity to HAP biological components and the ability to creation a bone-like porous structure. Recently applied nanotechnology has allowed fabricating HAP ceramics and coatings with particles 15-20 nm for high-strength orthopedic and dental composite. The advantage of the developed HAP is its beneficial biocompatibility and osteoconductivity for bone regeneration and formation of new bone tissue on their surface without any inclusion.

The electrical properties of HAP have also attracted the attention of many scientists and material biologists, because knowledge of the electric properties has been considered to be a great aid in understanding the cellular phenomena in bones and the developing of bone prostheses.

Recent advances in biomaterial research have revealed that electrically polarized HAP ceramics produce significant biological response (S. Nakamura, H. Takeda, K. Yamashita, J. Appl. Phys., 89, 5386 (2001)). It has been demonstrated that the enhanced bone formation is observed at the negatively polarized HAP ceramic surface when applied to colony formation of osteoblast-like cells, activation of gap junctions, and specific orienting of neuroblastoma cells. The polarized HAP ceramics are applicable to tooth root and total hip joint replacement systems and improve the performance of bone conductivity. The manipulation of bacterial adhesion and proliferation by polarization charges built onto the surfaces of electrically polarized bioceramic HAP was investigated. The gram-positive bacteria Staphylococcus aureus and the gram-negative bacteria Escherichia coli (E. coli) were cultivated on negatively polarized, positively polarized, and nonpolarized HAP surfaces (denoted as N-, P-, and 0-surface, respectively). The electrostatic force caused by the induced by bulk polarization charges experimentally was proven to affect both adhesion and proliferation. Compared with the 0-surface of HAP ceramics over 3-hours cultivation, the population of adhered bacteria rapidly multiplied on the N-surface whereas it multiplied quite slowly on the P-surface. The above results are attributed (1) to the electrostatic interaction between the cell surfaces and the charged surfaces of the polarized HAP, (2) to the stimulus of the electrostatic force for bacterial cells, and (3) to the concentration of the nutrient for the bacteria.

So far the observed biological effects are ascribed to bulk polarization charges reaching hundreds μC/cm² (S. Nakamura, H. Takeda, K. Yamashita, J. Appl. Phys., 89, 5386 (2001)). The proposed method of polarization is based on bulk electrical polarization of the ceramics by application of external electric field. According to these studies the tailored electric charge is ascribed to ionic polarization and partly related to migration of protons in the columnar (OH) channels of HAP (S. Nakamura, H. Takeda, K. Yamashita, J. Appl. Phys., 89, 5386 (2001) and M. Ueshima, S. Nakamura and K. Yamashita, Adv. Mater., 14, 591 (2002)).

Adsorption of bacteria to host tissue and to other bacteria is considered to be of fundamental importance. Recent studies (W. Clark, L. Bammann, R. Gibbons, Infect. Immun, 33, 908 (1978)) showed that hydrophobic properties of substrates are responsible for adsorption of variety of bacteria-host interaction. Many bacteria including streptococci, difhtheroides, filamentous forms, etc. exhibited pronounced ability to adhere to hydrophobic hexadecane indicating that the surfaces of these bacteria are hydrophobic in nature. Chemically saliva-treated HAP demonstrated hydrophobic properties which were confirmed by adsorption of the selected strains of dental-plaque bacteria (W. Clark, M. Lane, J. Beem, S. Bragg, T. Wheeler, Infect. Immun., 47, 730 (1985)).

The major trends in modern microelectronic, optical, chemical, pharmacological, and other material-based processing technologies are based on the development of smart substrates with modified physico-chemical interfaces which permit variation of their fundamental surface properties such as affinity to atomic/molecule adsorption and adhesion, chemical etching intensity, catalytic chemical activity, metal and dielectric layers deposition, hygroscopic ability, encapsulation, agglomeration, bonding, friction, flotation, etc. In the bio-medical field, fabrication of smart substrates is mainly directed toward creation of biocompatible and anti-infection properties. The developed technologies employ such diverse methods which bring about changes in the chemical identity, topographic features, charge state of the substrates by means of intermediate layers of different chemical origin, nanostructuring, tailoring of electret state. All these methods modify the free energy of the original surface of the substrates and subsequently several of its related key technological properties such as adsorption, adhesion, etching, bonding, friction, catalytic activity, biocompatibility, wettability, hygroscopicity, encapsulation, agglomeration, etc.

Modification of surface free energy and related properties of the solid materials suitable for material science-oriented technologies and biomedical applications presents the possibility of combining the ideal bulk properties (e.g. tensile strength or stiffness, electronic or optical properties) with the desired surface properties (e.g. adhesion, adsorption, wettability, selectivity to chemical interaction with particular molecules and biocells, biocompatibility, encapsulation, agglomeration, friction, etc). One of the appropriated and efficient ways to study and calculate the surface free energy involves surface wettability analysis.

Surface wettability is a paramount property of solid surfaces. The pioneering analysis of wettability has been presented by Young (Young, T. Philosophical Transactions R. Society, London, 95:65 (1805)) who considered the equilibrium state between forces acting on the contact line separating wetted and unwetted portions of a homogenous smooth solid surface. Young showed that the contact angle between deposited liquid droplet and material surface depended on energies associated with interfacial surface-liquid, surface-vapor and vapor-liquid and represented a complex fundamental property of solid materials and which could allow studying intermolecular interactions on the surface. Many physical effects in nature and applications in modern biology, medicine and technology, such as the manipulation of the hydrophobic interactions in protein adsorption, development and characterization of biomimetic materials, drug delivery, fabrication of superhydrophobic or superhydrophilic surfaces and self-cleaning mechanism, microelectromechanical systems (MEMS), bioMEMS and microfluidic devices, reduction of fluid resistance, bonding of materials, control over the orientations of liquid crystals, etc, are based on this wettability phenomenon (Abbott, Y.-Y., Science, 301:623 (2003); Bohringer, K. F. J. Micromech. Microeng., 13:S1 (2003); He, B., Patankar, N. A., and Lee, J. Langmuir, 19:4999 (2003)).

Surface wettability is one of the critical factors influencing adhesion of biological cells (An, Y. H., and Friedman, R. J. J. Biomed. Res., 43:338 (1998)). Furthermore, this important surface parameter is also often used in fundamental material research as an analytical technique (contact angle analysis) to characterize basic surface properties such as adhesion, adsorption, bonding and other properties in the micro- and nanometer scale (Ionescu, R. E., Marks, R. S., and Gheber, L. A. Nano Lett., 3:1639 (2003)). It should be emphasized that the effect is highly interdisciplinary, involving processes related to physical chemistry, solid state physics, soft matter physics, material science, etc. Thus, the wettability property and its controllable modification is a key physical and technological problem mainly for two groups of materials exploiting under different conditions and media: a) materials applied in microelectronics, microfluidics, pharmacology, construction industry, etc, and b) biomimetic materials used for biology, medicine, etc.

There are many methods to modify surface free energy and related properties (wettability, adsorption, adhesion, etc) of solid state surfaces (Lahann, J., and Langer, R. MRS Bullet., 30:185 (2005)). Most of them allow on-off switching of the aforementioned properties. Such modification can be achieved chemically, e.g., by altering the conformation of molecules at the surface. Self-assembled monolayers (SAM) of specific molecules are switched between different conformations, which then give rise to different surface free energies and wettability. External parameters for activating the wettability switching include ultraviolet (UV) light, temperature, pH, surface pressure or electrochemical processes. The achieved absolute variation in the wettability contact angle is rather small and accomplished by surface chemical reactions. In a contrast, electrically induced control of wettability is very reliable (Mugele, F., and Baret, J. C. J. Phys.: Condens. Matter., 17:R705 (2005)). The contact angle modulation reaches several dozens of degrees. However, the developed method of externally applied electric field cannot be applied in most of the aforementioned technologies and in-vivo biological experiments.

### GENERAL DESCRIPTION

There is a need in the art to modulate surface properties of a solid material (local or entire surface modification) in a controllable (and sometimes reversible) manner. This can advantageously be used in various applications, including material science, microelectronics, microbiology, molecular biology, and others at the macro-, micro- and/or nano-scale.

It should be understood that solid material to which the present invention applied includes any type of material including continuous surfaces, particulate material (e.g. powder, e.g. nano-scale powder), as well as porous material.

Surface free energies and its components between two interacting surfaces are critically important in a number of physical phenomena and technological applications. including adhesion, encapsulation, agglomeration, friction, bonding, coating operations, printing, de-inking, lubrication; as well as in biology, chemistry, biochemistry and others. Many of the other processing techniques, e.g. flotation, selective flocculation, filtration, thickening also depend on the interfacial interactions between solid and liquid, essentially water and organic liquids. These interactions are mainly controlled by the interfacial tension between two phases, which dictates the strength of interaction. The characterization of the surface properties, especially the surface free energy of the solids, is, therefore, recognized as the key to understanding the mechanism of surface-based phenomena. This information provides essential insight into the mechanism of such interactions as the stability of wetting, colloidal suspensions, molecular self-assembly, spreading, bubble-particle, particle-particle interaction in the industrial applications.

In the literature, various different approaches are mentioned which make it possible to evaluate the solid surface energy, using measured contact angles by liquids with known or pre-characterized surface energy parameters. In other words, a variation of the wettability is a variation of the surface energy.

The inventors have found that properties related to a surface energy of any solid state surface can be changed by inducing and/or varying surface properties of the material, and this without inducing or modifying any volumetric effects of the material such as defect structure, phase state of materials, etc.

The invention, thus, allows for inducing and/or varying a surface property of the material by a low-energy electron irradiation, and/or by combination of the later with electromagnetic radiation (e.g. light of a specific wavelength range). As a result, the method can provide switching or gradual tuning of surface properties, such as wettability, adhesion, adsorption, hygroscopicity, friction, encapsulation, agglomeration, etc. The induced variation of the surface properties can be totally reversed by applying electromagnetic radiation (e.g. in the UV or IR spectral regions) to the previously modified (electron irradiated) surface.

The developed method enables to change electron (hole) occupation of bulk traps in the vicinity of the surface and surface states, modify a spectrum of the surface states, etc. The method permits also modification of surface properties by applying to the surface an electron beam radiation or combination of electron beam with electromagnetic radiation with a specific wavelength.

The parameters of the electron irradiation, such as direction of electron beam propagation, current density of electron beam, electron energy, and/or duration (doze) of the irradiation, and possibly also parameters of the electromagnetic radiation (e.g. wavelength, intensity, polarization, and/or profile (time variation and duration)), are co-adapted to each material (and optionally to the effect to be achieved), so that the majority of the incident particles (electron and/or electron and photon) are absorbed in the surface layer. By this, the electron (hole) occupation of bulk traps and surface states as well as surface states and their occupation are modified resulting in variation of surface potential and surface energy without generating or modifying volumetric properties (the defect structure and phase state of the material).

The technique of the present invention permits controllable modification, imprinting and patterning of the surface properties thereby permitting reversible, variable tuning, imprinting and patterning of key material surface properties in a broad range, as well as other related properties such as wettability, atom, molecule and biomolecule adsorption, adhesion, biocompatibility, hygroscopicity, etching, encapsulation, agglomeration, friction, bonding, and other related properties. The method may find wide applications in many technologies based on the aforementioned surface properties, for example for antifouling, antifogging, anti-agglomeration, anti-hygroscopicity, microelectronics, technology of nanomaterials, printing, microfluidics (surface-immobilized drops and microchannels) for biochemical sensors, microengineering of smart templates for bioseparation, lab-on-chip systems, hydrophilic/hydrophobic patterned surfaces for DNA micro arrays, micro-, nanooptics, water cleaning technology, etc.

As indicated above, the invented technique allows flexible engineering of surface properties, or surface properties patterning of the material surface. For example, the nano-patterning of biological assemblies is a key for the development of novel biosensors and bio-MEMS devices. However, the ability to specifically and readily deposit biomolecules on functional surfaces is often limited by the need for chemical modification of the substrates. The invention, in some aspects, utilizes hydrophobic or electrostatic interactions for the design of bio-nanotechnology devices, specifically a new-generation biosensors. They are based on the basis of electron-induced effect and tailoring peptide structures with high resolution. The invention also provides for a technique for fabrication of templates with stable high resolution patterned and molded biocompatible cues for biosensors.

Surface modification of the materials for medical or biological applications presents the possibility of combining the ideal bulk properties with the desired surface properties such. as biocompatibility or selectivity to particular biomolecules adhesion and growth. The adhesion of cells and microorganisms on biomaterials such as materials used in orthopedic implants and contact lenses is strongly affected by the wettability (hydrophobicity/hydrophilicity) of the biomaterials substrates. The invented method for the engineering of surface properties presents a new approach to the material and biomaterial surface wettability (constituting a property relating to the surface energy of any solid state surface) modulation induced by a low electron energy irradiation, and/or combination of the later with electromagnetic radiation. The invented technique allows tailoring any wettability state in a wide range of contact angles θ, reaching Δθ˜120° by controlling the number of injected, generated and trapped electron (hole) charge.

It is known that in the field of contact lenses for example, one of the main problems is the “dry eye” problem and the adhesion of bacteria, leading to infections. The adhesion of bacteria is also a problem for the Ti-based implants, in addition to the problems of fouling by blood proteins, such as fibrinogen, which results in blood clotting. For orthopedic and dental Ti-based implants it is also desirable to create surfaces that block adherence of bacteria but promote adherence of osteoblasts. Both types of materials—contact lenses and Ti-based implants—need fabrication of a specific modified surface energy state (wettability state), creating optimal adhesion/non-adhesion properties which will prevent adhesion of bacteria and blood proteins, and (optimally) stimulate adhesion of osteoblasts. The invented technique allows fabricating different susceptibilities of biomaterials surface to infection, because adhesion and growth of infecting bacteria may be controlled by the surface hydrophobicity. Thus, fabrication of a desirable wettability state by the technique of the present invention allows for the possibility of improving biocompatibility and bacteria protection.

It should be understood that the minimal dimension of a modified surface feature, or in other words the resolution of patterning achievable by the technique of the present invention, is defined by a cross-sectional dimension (diameter) of the electron beam, and can thus be in the nanometer scale with the existing technologies in this field. It should also be understood that the technique of the present invention provides for modifying large surface areas of the material.

There is, thus, provided according to one broad aspect of the invention, a method for modifying properties of a solid material, the method comprising irradiating at least a region of the material by an electron beam optionally in a combination with electromagnetic radiation, e.g., at least one of light and heat and controlling at least one parameter of said radiation, in accordance with said material, in order to modify a surface property of the material within said at least region thereof, e.g. in a reversible manner, by inducing or varying a surface potential and/or a surface energy within at least one region so as to induce a change in the surface property without affecting any structural or phase state modification of the material within said at least one region.

In some embodiments, the surface property is one or more of adsorption, deadsorption, adhesion, chemical reactivity, stability to reactive materials (chemical resistivity), friction, catalytic reactivity, biocompatibility, wettability, hygroscopicity, ability to encapsulate materials, ability to agglomerate in the presence or absence of one or more additional materials, ability to electrostatically interact with one or more other materials, affinity to a certain material, and the ability to undergo pulverization.

In some embodiments, the electron beam is a low energy beam, typically the energy substantially not exceeding 1000 eV.

As indicated above, the modification of the property(s) of the material does not substantially induce or further modify any defect structure or the phase state of the material (isomerization, polymerization).

The controllable parameters in case of electron beam irradiation include at least one of current density, energy and duration of the applied charged particles' (electron) beam radiation and in case of the electromagnetic radiation may alternatively or additionally include its intensity, wavelength and direction of propagation.

In some embodiments of the invention, the modifying of the surface property of the first material by irradiation with an electron beam is aimed at modifying the affinity of the surface of said at least one selected region of the first material to which the electron irradiation is applied, towards a second foreign material (such as a biological material), thereby further affecting attachment (adhesion/coupling or non-adhesion/non-coupling) of the first and second materials. The electron irradiation may be performed on selected regions of the material, thereby creating a pattern formed by an array (one- or two-dimensional array) of spaced-apart surface modified regions (of the same or different geometry as the case may be), thus further promoting the second material attachment only to said surface modulated regions while preventing the material attachment to the spaces between these surface modulated regions.

The foreign material may for example be metal, dielectric, semiconductor, polymer, or any other material of various origin and dimension including nanoparticles as well as biological materials such as biocells, biological molecules such as nucleotides, polypeptides, small organic compounds, blood components, bacteria, fungi, and others as known to a person skilled in the art. The material adhesion may be for the purpose of bonding, creation of new coats, construction of biosensors for various applications, formation of a patterned biological structure, coating of a surface with a layer of biological compounds, creation of filtration tools or tools for the separation of mixtures (such as oil from water), and others. Similarly, a pattern can be created of the spaced-apart regions of a certain affinity different from that in the spaces between said regions, as further disclosed herein.

According to another broad aspect of the invention, there is provided a method for use in crystallizing a solid material, the method comprising applying radiation to at least one region of said material using an electron beam to modify a surface property of said material within said at least one irradiated region thereof, thereby crystallizing said material within said at least selected electron irradiated or non-irradiated region thereof.

According to yet another broad aspect of the invention, there is provided a method for use in effecting attachment/detachment of first and second solid materials to or from each other, the method comprising applying radiation to at least one region of either one or both of the first and second solid materials using an electron beam to modify a surface property of said at least one region as compared to its surroundings within the respective material, thereby providing attachment/detachment of the first and second materials within said at least region of the modified surface charge and/or surface energy property.

In some embodiments of the invention, the second material is to be attached to the first material at least within the selected surface region thereof, while in the initial, non-modified state of the first and/or second material within said at least one surface region, such attachment cannot be achieved. In some other embodiments, the first and second materials in their non-modified state are attached to one another at least within a selected surface region at the interface between them, while modifying said at least one surface region allows non-attachment of the first and second materials. The case may be such that the first and second materials, before being modified, can be attached to one another, while by modifying at least a selected region of the first and/or second materials, the attachment can be achieved along the interface between the materials, except for said selected region.

It should be understood that where the method of the invention is utilized for the attachment of one material to another, the same method may be used for controlling the non-attachment of the two, namely the ability of the two materials to resist attachment to each other.

According to yet another broad aspect of the invention, there is provided a method for use in material removal, the method comprising applying electron irradiation with at least one controllable parameter to an array of spaced-apart surface regions of a solid material so as to create the array of the surface regions having modified surface-related property; and applying a material removal process to said material thereby removing the material from the spaces between said surface-modified (or non-modified) regions, while substantially leaving the material within said regions.

With respect of this aspect of the invention, it should be emphasized that the application of electron irradiation allows creating a pattern in the form of spaced-apart regions, of any shape and/or size, of the modified surface property, without causing any material removal in said regions and spaces between them. The process of the invention is, thus, capable of varying, e.g., increasing, decreasing and/or fine tuning, the ability of a so-irradiated material in accordance with the invention, typically with energy up to 1000 eV, to undergo chemical etching. The solid material is for example ZnO, Cu, glass, SiO₂ and others.

According to yet another broad aspect of the invention, there is provided a device for modifying a property of a solid material, the device comprising an electron beam source configured and operable to generate a low energy electron beam for irradiating at least a selected region of the material, and a control unit for operating said source to control at least one parameter of said electron beam in accordance with said material so as to induce or vary a surface potential and/or surface energy within said at least selected region and thereby induce a change in the surface property while avoiding any structural or phase state modification of the material within said at least selected region, the device being therefore configured and operable as a modifying device for modifying a surface property of at least the selected region, in a manner enabling a change of the surface property.

As indicated above, the device may also include electromagnetic radiation source, at least one of light and heat radiation source, to be applied to at least one surface region of a solid material while being irradiated by the low energy electron beam, enabling a reversible change of the surface property.

According to yet another aspect of the invention, there is provided a device for modifying surface properties of an implant material, the device comprising: a source of electron irradiation configured for generating a low energy electron beam to be applied to a surface of the implant; and a control unit for operating said source to control at least one parameter of the electron beam capable of affecting a surface property of the material, the device being therefore configured and operable as a modulator device for modifying a surface property of at least the selected region of the implant's surface to which the electron irradiation is applied, in a manner enabling a reversible change of the surface property.

According to yet another aspect of the invention, there is provided a biosensor device comprising: a source of radiation configured for generating a charged particles beam to be applied to a surface of a first material; and a control unit for operating said source to control at least one parameter of the irradiation capable of affecting a surface property of the first material, the device being therefore configured and operable for identification of a second material by its ability to couple or non-couple to said at least one region of the first material to which the radiation has been applied.

According to yet another aspect of the invention there is provided a solid material having at least one surface region or a pattern of spaced-apart surface regions of a surface property different from surrounding regions of said material.

According to yet another aspect of the invention there is provided a lens having at least one surface region of a surface property different from surrounding regions of the lens material, thereby preventing fogging of said lens within said at least one surface region.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic representation of the conventional sessile drop method used to determine surface energy by wettability.

FIG. 2 is a schematic illustration of the virtual displacement of the contact line at a fixed total volume of the system, according to the technique of FIG. 1.

FIG. 3 depicts water contact angle measurements obtained on an azo-initiated PNIPAM film as a function of temperature, according to the technique of FIG. 1.

FIG. 4 is an idealized representation of the transition between straight (hydrophilic) and bent (hydrophobic) molecular conformations.

FIG. 5 depicts the potential-induced molecular motion due to the redox reaction of a bipyridinium monolayer assembled on a gold electrode. The molecular design resembles an electrochemically activated molecular “arm”. Redox-induced rearrangement results in macroscopic changes of interfacial properties.

FIG. 6 is a block diagram illustration of a device configured and operable according to the invention for modifying a property of a subject material.

FIG. 7 is a block diagram illustration of a device of the present invention configured for creating a pattern of different surface properties related to surface energy on the subject material, using a mask or by direct scanning, using electron beam or combination of the electron beam irradiation with electromagnetic radiation via mask or by direct scanning.

FIG. 8 is a block diagram illustration of a device according to the invention for material attachment (adhesion or coupling) to a subject material.

FIGS. 9A and 9B depict the biosensing method of the invention: FIG. 9A shows a device of the invention and FIG. 9B depicts the utilization of the device as a biosensor, by coupling with, a certain biological material.

FIGS. 10A and 10B schematically exemplify the use of a device of the invention in modifying a surface of an implant.

FIG. 11 illustrates an AFM image of HAP ceramics topography: the image labeled A is of a HAP ceramic type “A” and the image labeled P is of type “P”.

FIG. 12 shows the excitation spectrum of photoluminescence (PL) for both the type “A” and type “P” HAP ceramics.

FIG. 13 shows the light induced variation of contact potential difference, ΔCPD, for both investigated HAP ceramics samples (“A” and “P”).

FIG. 14 shows the electron energy structure of the studied HAP ceramics.

FIG. 15 shows the contact angle of untreated HAP samples “A” and “P”

FIG. 16 demonstrates the inhomogeneity of an untreated implant. Water droplets deposited on the implant surface show two hydrophobic regions and one hydrophilic region.

FIG. 17 shows electron beam irradiation affording the transition of HAP ceramics from hydrophilic to hydrophobic states.

FIG. 18 shows the gradual change in wettability afforded by gradually varying the time exposition of the irradiated sample from t₁ to t₄.

FIGS. 19A and 19B show the wettability modified hip implant; FIG. 19A shows the hydrophilic unmodified implant and FIG. 19B shows the less hydrophilic implant resulting from irradiation of its surface.

FIG. 20 shows the morphological structure of tissue plates, grown on untreated hydroxyapatite surfaces of disks implanted under skin of mice. The sites of a loose nonformed connective tissue (1) are defined, cross-stripped muscular fibers (2). The samples were colored with gematoxylyn-eozin ×200.

FIG. 21 shows the morphological structure of fabric plates evolved on hydroxyapatite coatings pretreated in a low doze (Q˜10 μm/cm²). The samples were colored with gematoxylyn-eozin ×100.

FIG. 22 presents the results of glass surface properties modification to control patterning of fibroblast cells.

FIG. 23 shows the results of glass surface properties modification to control patterning of stem cells.

FIG. 24 demonstrate tunable hydrophobicity of a Si substrate, without chemical or mechanical treatments of the surface (the three pictures labeled a-c at different angles).

FIGS. 25A-25C shows the various channel structures formed on a Si-substrate: FIG. 25A shows micro-channel structures; FIG. 25B shows water matrix; FIG. 25C shows open-air water microchannels.

FIG. 26 shows a patterned substrate obtained from deposition of Co metal on a modified Si-substarte.

FIG. 27 shows the structured crystallization of Na₂CO₃ on a Si-substarte.

FIG. 28 demonstrates the tunable hydrophobicity of a silicon oxide surface (the three labeled pictures a-c at different angles).

FIGS. 29A and 29B demonstrate a micropatterned surfaces such as isolated water (liquid) matrices (FIG. 29A) and water microchannels (FIG. 29B) on silicon oxide surfaces.

FIGS. 30A-30D show that differences in surface properties, such as wettability, result in a differential binding of biological molecules, in correlation with their level of hydrophobicity. FIG. 30D shows the adhesion of bovine serum albumin (BSA) (upper row) and DNA (lower row) to the hydroxyapatite surfaces with different wettability state (θ is the contact angle). The ceramic samples were Giemsa stained and the biomolecules are stained in red.

FIG. 31 depicts the adhesion of various bacteria (white, gray and black bars refer to E. coli, P. putida, and B. subtilis, respectively) on the hydroxyapatite surface as a function of wettability modulation, induced by low-nergy electron irradiation. The proportion of the total field of view that is covered by settled bacteria is determined by image analysis and is expressed as percentage coverage. The error bars refer to the statistical errors. The dashed line at Q=60 μC/cm² (θ=50°) distinguishes between low and high dose regions of irradiations.

FIG. 32 shows a picture showing the adhesion of baker's yeast to Si surfaces with different surface properties.

FIG. 33 demonstrates the result of electron beam charging of glass material.

FIG. 34 demonstrates the result of electron beam charging of Ti, Ag, and Al₂O₃ surfaces.

FIG. 35 shows before and after electron beam charging of paper.

FIG. 36 demonstrates a patterning on SiO₂ surface using combination of electron irradiation and electromagnetic radiation (light illumination).

FIG. 37 exemplifies the effect on the surface properties of a glass surface to control and modify the floating/sinking properties.

FIGS. 38A-C show the three-dimensional rendering of atomic force microscopy (AFM) scans of three lenses, all fabricated with a 600 nm diameter pipette, using the same deposition time (10 sec) and the same prepolymerization fluid. FIG. 38A—Incident surface charge density of Q˜120 μC/cm² led to a contact angle θ=11°. FIG. 38B—The measured contact angle here is θ=16°, with a irradiation resulting in Q˜50 μC/cm². FIG. 38C—The measured contact angle of this lens is θ=22° on a surface irradiated with Q˜5 μC/cm².

FIGS. 39A and 39B show diameters of lenses ranging between 8 μm (untreated surface) and 19 μm (sample with incident surface charge density of Q=120 μC/cm²) for deposition time ranging between 1 and 20 sec, respectively. It can be seen that the irradiated surfaces produce differing geometric properties of the lenses having kept all other parameters nominally constant. FIG. 39A—The lens' diameters increased with rise in incident surface charge density. FIG. 39B—The radius of curvature of the lenses increased with higher incident surface charge density.

FIGS. 40A and 40B show a distinctive polymer channel according to the invention with a characteristic shape on glass. FIG. 40A—Surface energy patterning was performed by electron beam irradiation. FIG. 40B—Polymer channel exhibits a single bulge with a characteristic shape on glass. The bulge state can be used to construct channel networks that could be used as fluid microchips or microreactors. Surface energy patterning was performed by electron beam irradiation.

FIG. 41 shows a contact mode atomic force microscopy (AFM) image of photolithography patterning on Si surface.

FIG. 42A-42E demonstrate the results of SiO₂ surface properties modification to remove oil from water. FIG. 42A—Initial stage, distilled water is added to a glass vial; FIG. 42B—Drop of oil-based liquid is added to the same vial; FIG. 42C—Sample with modified surface properties is added to the vial containing the water and oil; FIG. 42D—After the sample is removed out from the glass vial, no oil remained in the vial; FIG. 42E—the oil, which was preliminary added to the water, is now found on the sample, which was preliminary irradiated by the presented invention.

FIG. 43 exemplifies the removal of Cu powder from a liquid using a surface irradiated according to the method of the invention.

FIG. 44 shows a schematic representation of preliminary patterned by electron beam substrates.

FIGS. 45A and 45B show aluminum metal vacuum sputtering on Si substrate: FIG. 45A—after electron irradiation (no Al adhesion) and FIG. 45B—untreated one demonstrating excellent Al adhesion.

FIGS. 46A-46C are pictures of Si surfaces modified in accordance with a method of the invention to control patterning of peptide nanotubes.

FIGS. 47A-47D are pictures of Si surfaces modified in accordance with the invention to control patterning of peptide nanospheres.

FIG. 48A shows a contact mode atomic force microscopy (AFM) image of electron modified monolayer formation on a SiO₂ surface with 100 nm period grating at (electron energy Eₚ=1000 eV and Q=50 μC/cm². No processing was performed between patterning and imaging. FIG. 48B shows a cross section which reveals feature sizes of 0.7-0.8 nm.

FIG. 49A shows a contact mode atomic force microscopy (AFM) image of chemical monolayer formation on a SiO₂ surface after 10 nm period grating at Eₚ=1000 eV and Q=50 μC/cm². No processing was performed between patterning and imaging. FIG. 49B shows a cross section which reveals feature sizes of 0.6-0.8 nm.

FIG. 50 presents the capacitance-voltage (C-V) characteristic of the SiO₂ samples with (dotted and solid lines) and without (dashed line) the organic layer. The dotted and solid lines refer to various incident electron charges, Q=10 and 150 μC/cm², respectively.

FIG. 51A shows a contact mode atomic force microscopy (AFM) image of SiO₂ surface after electron irradiation by scanning electron beam (100 nm period grating at Eₚ=1000 eV and Q=50 μC/cm ) followed by chemical etching (10 sec etch in 6:1 HF solution). FIG. 51B shows a cross section which reveals trenches being 20 nm in size. The etching rate was much less in the electron irradiated region which the evidence of formation of electron-modified protective layer on SiO₂ surface.

FIGS. 52A-52C present the atomic force microscopy topography imaging of SiO₂ sample. FIG. 52A—untreated sample; FIG. 52B—a treated sample after selective electron irradiation (Ep=100 eV and Q=50 μC/cm²) followed by chemical etching (two dimensional image); and FIG. 52C—three dimensional fragment of the etched sample. The etching rate was much less in the electron irradiated region which the evidence of formation of electron-modified protective layer on SiO₂ surface.

FIG. 53 depicts the results of etching rate in 0.1M oxalic acid for untreated (I) and electron irradiated (II-IV) ZnO-coated films. Bars II-IV refer to the ZnO-coated films irradiated with a dose of the incident electron charge of Q=120, 270 and 360 μC/cm², respectively.

FIG. 54A shows a contact mode atomic force microscopy (AFM) image of a difference in chemical etching rate in ZnO surface after 60 sec etching in 10% NaOH. The right size, with higher chemical stability, was irradiated by electrons with energy Eₚ=1000 eV and incident charge of Q=360 μC/cm². No processing was performed between etching and imaging. FIG. 54B shows a cross section which reveals “step” sizes of ˜130 nm.

FIG. 55A shows a contact mode atomic force microscopy (AFM) image of difference in chemical etching rate at ZnO surface. The right size, with higher chemical stability, was achieved by two-step process. Each step include irradiation by electrons with energy Eₚ=1000 eV (incident charge of Q=360 μC/cm²) and 30 sec etching in 0.1M oxalic acid. FIG. 55B shows a cross section which reveals “step” sizes of ˜120 nm.

FIGS. 56A and 56B show a three dimensional patterned array on a 170 nm thick ZnO-coated glass sample. The array was prepared by chemical etching of preliminary patterned ZnO sample in 10% NaOH solution for 60 sec. The patterning was performed by local electron irradiation with energy Eₚ=1000 eV (Q=300 μC/cm²), using scanning electron beam. The etching rate was much less in the electron irradiated region which the evidence of formation of electron-modified protective layer on SiO₂ surface.

FIG. 57 depicts the results of optical transparency measurements on untreated (top line) and high dose (Q˜400 μC/cm²) electron irradiated (lower line) ZnO-coated sample.

FIGS. 58A and 58B demonstrate modification of hygroscopic properties. Water droplets behavior on untreated (FIG. 58A) and electron irradiated (FIG. 58B) calcium acetate powder, 5 sec after the water droplets were deposited on it. Treatment was performed by electron irradiation, Eₚ=500 eV, Q=300 C/cm².

FIG. 59 demonstrates the variation of calcium acetate powder weight versus time. Treatment was performed by electron irradiation, (Eₚ=500 eV, Q=300 μC/cm²).

### DETAILED DESCRIPTION OF EXEMPLARY EMBODIMENTS

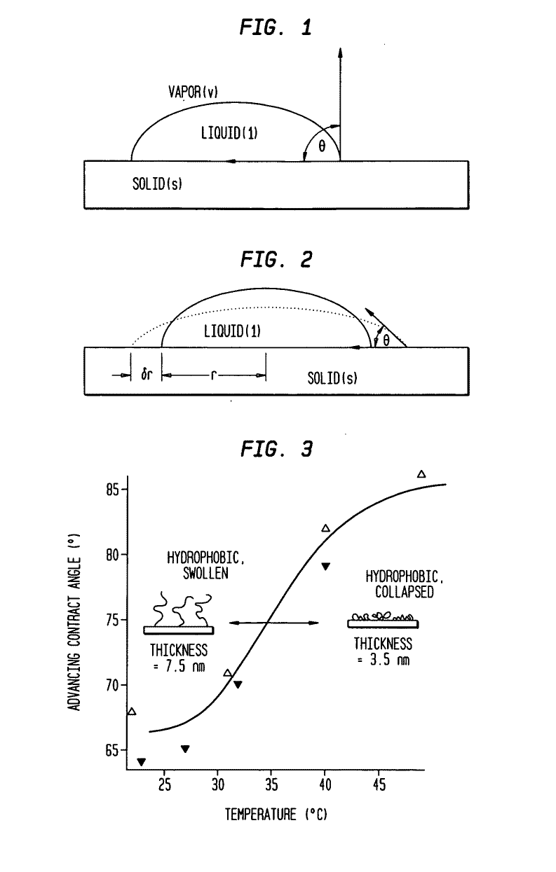

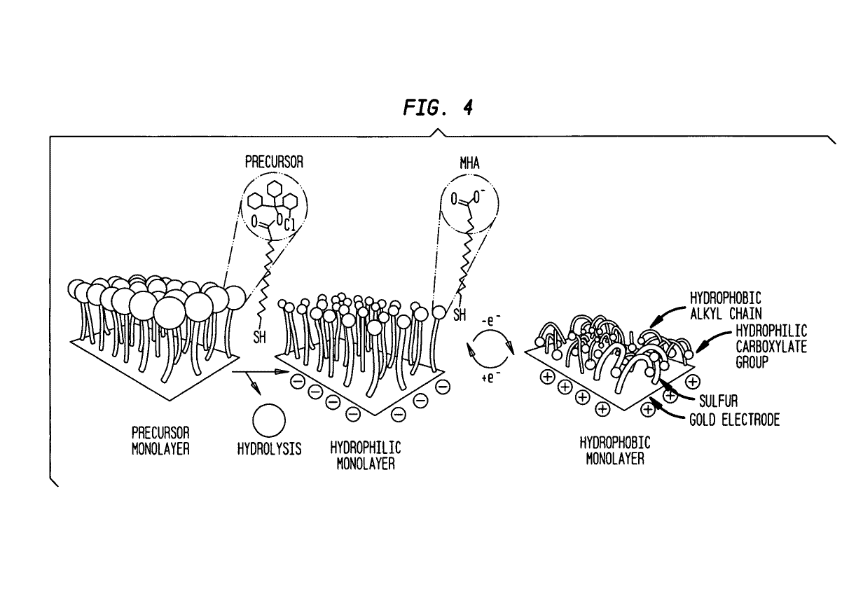

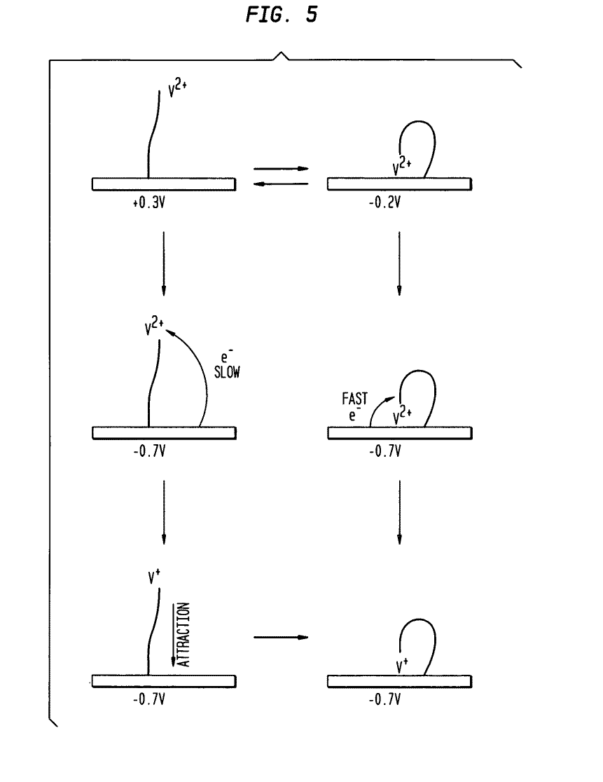

FIGS. 1 to 5 are related to the background of the invention.

To facilitate understanding, the same reference numbers are used for identifying components that are common in all the examples of the invention.

Device Constructions According to the Invention

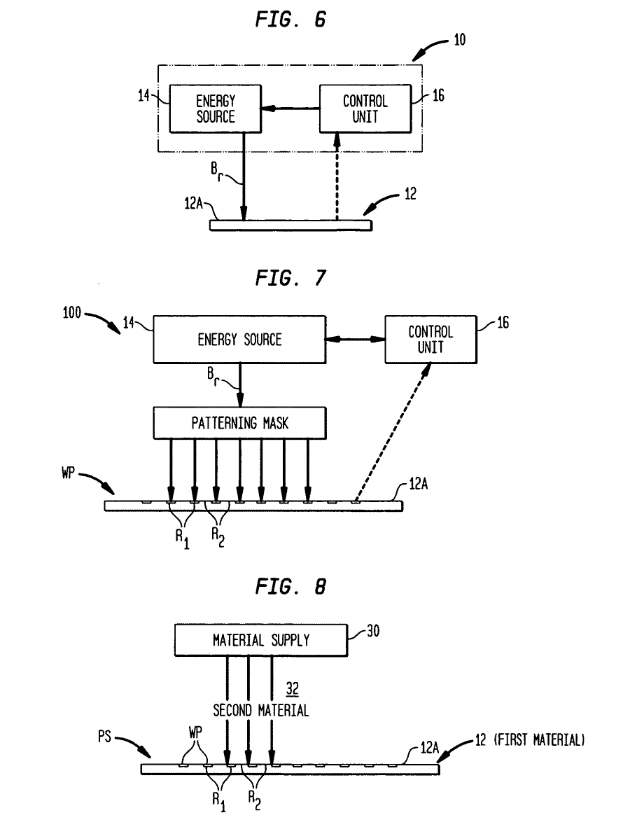

Referring to FIG. 6, there is illustrated, by way of a block diagram, a device 10 of the present invention configured for modifying surface properties of a subject material 12. The device 10 includes an electron beam source 14 and a control unit 16. Optionally, the device 10 may also include an electromagnetic radiation source (not shown). This may be a light and/or temperature source. In this case, the same control unit 16 or another one is used for controlling the operation of the electromagnetic radiation source.

The electron beam source 14 is configured and operable for applying an electron beam of certain selected parameters to a surface 12A of the subject material 12 at least within a selected region of the material. The parameters of the electron beam are selected in accordance with the material in use and an effect to be achieved, namely modification of the surface property(s) affecting affinity, wettability, adhesion, adsorption, hygroscopicity, friction, encapsulation, agglomeration and other related surface energy parameters. Such electron beam parameters include a direction of beam propagation, energy, current density and duration (dose). If light is to be applied to the irradiated surface, the light parameters are to be adjusted accordingly, namely wavelength and/or intensity and/or polarization and/or duration (profile).

The control unit 16 is configured for operating the electron beam source (and possibly also the electromagnetic radiation source) to control one or more parameters of the applied radiation. As indicated above, such parameters include for example current density, energy, direction of propagation and/or duration of the applied electron beam. To this end, the control unit is configured as a computer system including inter alia a memory utility for user input of the material being modified and/or electron beam parameters to be kept, and possibly also a data presentation utility (display). The case may be such that the control unit includes a data processor, which is preprogrammed with a suitable algorithm for setting the electron beam parameters in accordance with the user input about the material in use and the effect to be achieved. The control unit 16 may also incorporate a measurement unit (not shown) for controlling the static charge being created (as well as charge being then removed, as the case may be) by carrying out measurements of the charge and/or the surface energy and/or other surface properties.

The device 10 is thus configured as a device for modifying the surface properties of at least the selected region to which the electron irradiation is applied. Moreover, the so-modified surface properties can be reversed, for example by radiating the respective region by electromagnetic radiation with specific wavelength, intensity and duration. It is important to note that the surface properties modifying technique of the present invention does not cause any volumetric changes in the subject material (i.e. creation of defects, change in the phase state of the material, etc.).

The device 10 can for example be used for creating a pattern of surface properties of different regions within the surface 12A of the subject material 12. Such a pattern may be aimed at further carrying out selective etching, adsorption of metals, ions, adhesion of biomolecules, microorganisms, biocells, etc. The patterning can be performed by providing a relative displacement between the electron beam Bᵣ (or a combination with electromagnetic radiation with specific wavelength, intensity and duration) and the subjected material. Another option is by using the energy source capable of generating a plurality of spatially separated beam components, for example by using a matrix of point-like electron sources (e.g. carbon nanotubes) or/and of a matrix electromagnetic radiation emitters.

Yet another possible implementation for the patterning embodiment is to pass the electron beam source through a mask or by direct scanning, using electron beam alone or combination of the electron beam irradiation with electromagnetic radiation via mask or by direct scanning. This is exemplified in FIG. 7. A surface properties modulator device 100 includes an electron beam source 14 associated with a patterning mask 18; and a control unit 16.

As indicated above, the proposed surface properties modification technique of the present invention affects neither the defect structure nor the phase state of the material bulk (isomerization). Thus, as shown in FIG. 7, a surface properties pattern SP created on the surface 12A is in the form of an array (one- or two-dimensional array) of regions R₁ of the modified surface properties (i.e. the irradiated regions) spaced by regions R₂ of non-modified surface properties. The regions R₁ as well as regions R₂ may be of the same or different geometry, depending on the mask used in accordance with a desired pattern to be obtained.

The surface properties pattern creation may be used as a preliminary step to facilitate one or more of a material's wettability, adhesion, adsorption, bonding, friction, encapsulation, agglomeration, etching, etc. This is schematically illustrated in FIG. 8 showing a material supply tool 30 for supplying a certain foreign material onto the patterned structure PS of the first material 12 with the surface properties pattern SP. Due to the pre-created pattern SP, a second material 32 can be adhered (non-adhered) or coupled (non-coupled) (chemically or physically) to the entire surface 12A, and the second material 32 will couple to or react with the first material only within the regions R₁ of the modulated surface properties or only within the spaces R₂ between them depending on the affinity properties of the second material.

Turning back to FIGS. 7 and 8, in some other embodiments, the surface properties modifying of the subject material 12 can be used for allowing or preventing (e.g. selectively) crystallization of another material thereon. This can advantageously be applied to materials which otherwise would not have a chemical or physical tendency to crystallized on the surface. The invention can thus be used for creating a crystalline layer of a first material on the surface of a second non-crystalline material or creating a pattern of spaced-apart crystalline regions of the first material on the second substrate material, by previously adjusting the surface properties of the second material. This can for example be used for creating an array of spaced-apart crystalline regions, which can then be used for manufacturing a corresponding array of electronic devices.

### Biomedical Applications

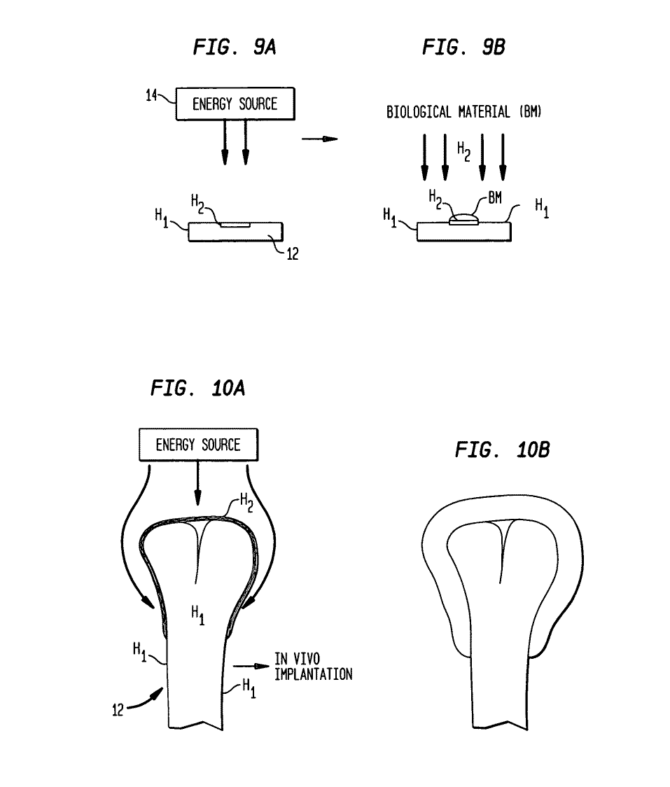

The use of the technique of the invention in biosensing and medical applications is exemplified in FIGS. 9A and 9B. FIG. 9A shows an energy source 14 of a surface properties modifying device of the present invention applied to a subject material 12 to create a surface properties modulated region R₁. It should be understood that such region R₁ may be the entire surface 12A of the subject material. In the present example, the subject material 12 is originally hydrophilic H₁. The surface properties modification, resulting in a modification in a surface property (e.g., wettability), shifts the irradiated region into a hydrophobic state H₂. As shown in FIG. 9B, the so-shifted structure is then used as a biosensor capable of sensing, by coupling with, a certain biological material BM. In this example, the biological material has hydrophobic properties or hydrophobic functionalities, and accordingly will couple only to the hydrophobic surface, region H₂ in the present example. It should be understood that in case the biological material to be detected has hydrophilic properties or hydrophilic functionalities, it would couple to the regions H₁, or the biosensor would be prepared with the entire modulated surface H₁. By this, the presence of the specific biological material in the surroundings of the subject material 12 can be identified and/or quantified.

Reference is made to FIGS. 10A and B schematically exemplifying yet another embodiment of the invention. In the present example, the invention is used for creating a biological implant. As shown in FIG. 10A, a joint implant 12 is irradiated by the surface properties modulator device of the present invention so as to create on the hydrophilic H₁ implant a modulated hydrophobic region H₂ thus having high or improved biocompatibility to certain tissues (e.g. connective tissues). The so-created implant, when implanted in a body, will cause improved growth of such tissues only within the respective region H₂.

The inventors have applied the developed method modifying a surface property of diverse substrates such as:

a. biomimetic and biomaterials such as Hydroxyapatite (HAP) bioceramics, HAP synthesized ceramics, human implant with HAP coatings and related Calcium phosphate materials, hydrogel, sea shells, and others;

b. Si-based materials: P- and N-type Si, glass, silicon oxide, silicon nitride, fused silica,

c. dielectric amorphous materials, crystalline materials and ceramic materials such as mica, and alumina;

d. metals such as Al, Cu, Zn, Ag, Co, Pd, Ti, and another metals which may or may not be coated by native oxides; and

e. other materials: ferroelectrics, paper, etc.

The analysis of physical origin of surface properties shows that properties related to the surface energy of any solid state surface critically depend both on the basic intrinsic physical properties, such as interfacial surface energies-energy interactions of original surface material/liquid, original surface material/vapor, and on the extrinsic properties, which can be varied such as topographic morphology (surface roughness), surface charge, etc.

Another factor strongly influencing the surface properties relating to the surface energy is the surface charge. This may be flexibly changed by an externally applied electric field or bulk polarization. However, the known method of affecting the surface charge by an externally applied electric field cannot be applied for in-vivo experiments and conditions; the application of the method is also problematic in liquid conductive media. In addition it does not allow any properties relating to the surface energy patterning on the surface substrate. The known method using preliminary bulk polarization of a HAP substrate cannot provide a stable polarized state due temperature fluctuations and high conductivity of HAP. The measurements conducted by the inventors showed that the bulk conductivity of HAP is about 10⁻⁸ Ω⁻¹cm⁻¹. For low dielectric permittivity of HAP which is around 10, the estimated characteristic relaxation time does not exceed several milliseconds. Such a short time of screening of the bulk polarization points to a strong instability of the known method of HAP wettability monitoring. As in the previous case, no wettability patterning on the surface HAP substrate is achievable.

According to the invention, the properties relating to the surface energy variation is obtained by modification of the surface charge of the material without generating or modifying bulk and surface defects or phase state of materials. Contrary to the known techniques, the surface charge modification leading to the wettability or/and other properties related to the surface energy modification is achieved by applying radiation (electron beam, electromagnetic radiation) to the subjected material.

Biomaterials are divided into several groups; animal or human material, metals, polymers, ceramics and composites. For example, bioceramics like bioactive HAP, bio-inert alumina and porous hydroxyapatite coated metals and alumina have long been used in orthopedic surgery. Physical properties of biomaterial surfaces are critical to the study of biomaterials. The nature of an implant's surface determines its interaction with the body fluids, in particular with proteins, which, in turn leads to cascades of reactions comprising the body's response to the implant and determining the development of the implant/tissue interface. The surface characterization of biomaterials is therefore particularly important.

Photoluminescence, surface photovoltage spectroscopy and high-resolution characterization methods (Atomic Force Microscopy, Scanning Electron Microscopy, X-ray spectroscopy and DC conductivity) applied to nanostructural bioceramics Hydroxyapatite allowed studying electron (hole) energy states spectra of HAP and distinguishing bulk and surface localized levels.

HAP nanopowder was fabricated using both fine mechanical treatment and chemical reactions. Mechanical activation was performed under air environment in a planetary mill containing two steel drums and steel balls. Transmission Electron Microscopy (TEM) analysis showed that the size of powder particles was about 20-100 nm. Particles, typically 40 nm in size, were extracted for the ceramics manufacturing and used as a raw material for preparation of ceramic platelets.

Two sorts of HAP nanopowder “A” and “P” were used for ceramic samples fabrication. HAP powder “P” was annealed at 900° C. for two hours and then dispersed in alcohol for two minutes whilst powder “A” was not subjected to any thermal radiation. Such a preliminary high temperature radiation of the powder “P” lead to a strong dehydration of HAP which was confirmed by subsequent XPS analysis of the HAP ceramics samples. The platelet-like samples (h=2-3 mm, Ø=5 mm) were fabricated using dry pressing HAP powders (0.1 g±0.005). A press form greased by rapeseed oil was used for two stage compaction. Pressure of 250 MPa and 350 MPa was applied during the first and second stages, respectively. After pressing, the resulting ceramic bodies were sintered with heating rate of 5° C./min to 1100° C. annealing at that temperature for 1 hour. Sintered platelets were cooled down to room temperature within an oven.

High-resolution XPS analysis was used to characterize the chemical composition of the HAP ceramics. The measurements were performed in ultra high vacuum (3×10-10 Torr pressure) using 5600 Multi-Technique System (PHI, USA). The samples were irradiated with a monochromatic Al Kα source (1486.6 eV) and the resulting electrons were analyzed by a Spherical Capacitor Analyzer using the slit aperture of 800 μm. Topography features were observed by AFM (Multimode; Digital Instruments) in tapping mode and were also imaged by SEM using a Raith 150 Ultra High Resolution E-Beam Tool (Raith; GmbH Germany). Additionally, the roughness and the porosity analysis were performed using the WSxM 4.0 Develop 6.1 scanning probe microscopy software from Nanotec Electronica S.L. The DC conductivity measurements were conducted by HP-4339 High Resistance Meter in conjunction with a HP-4284 Precision LCR Meter, which cover the regions of 20 Hz to 1 MHz.

Optical absorption spectra were measured with a Genesis-5 spectrophotometer (Milton Roy, USA) equipped with PC-IBM. Photoluminescence (PL) excitation and emission spectra were measured with a FP-6200 (Jasco, Japan) spectrofluorometer supported by a Pentium 4 computer. The system employed high quality components designed around a DC powered 150 W Xenon lamp. The lamp output was monitored with maximum stability ensured by the use of a reference silicon photodiode. The signal-to-noise ratio of the instrument was around 450:1. The wavelength range provided by the FP-6200 is 200 nm to 800 nm (excitation) and 200 nm to 900 nm (emission) with the WRE-362 red sensitive photomultiplier. Appropriate Long Pass and Cut Off optical filters were applied in order to exclude stray light and second-order effects.

The PL excitation bands were resolved into individual Gaussian components using equation:

$$I = {I}_{max} exp [ - {( \frac{ℏω - {ℏω}_{0}}{2 {σ}^{2}} )}^{2} ]$$

where I is the PL intensity at photon energy Imax, w is the maximum intensity of the individual band, w₀ is the exciting photon energy at Iₘₐₓ, and σ is the band width connected with the Full Width-Half Maximum (FWHM) by equation:

FWHM=2 ln(2)^{1/2}σ

The “Peak-Fit” deconvolution program uses the least square linear mixed model (LMM) method with simultaneous variation of all or some of the excitation bands parameters (photon energy or alternately—band energy, FWHM, PL intensity) together with fitting baseline to obtain the minimum chi-square.

Surface Photovoltage Spectroscopy (SPS) studies are based on the Kelvin probe technique, which measures the contact potential difference (CPD) between a vibrating reference probe and a sample surface subjected to a light illumination. Illumination of the sample surface by monochromatic light resulted in direct modification of the surface charge, and hence resulted in a potential due to photogeneration and separation of charged carriers. Therefore, the obtained photo-induced variation of ΔCPD spectrum contained information about the semiconductor type of conductivity, electron affinity, band gap local states and built-in potentials. It should be noted that a great advantage of SPS compared to PL optical method is an opportunity to distinguish between electron and hole traps by estimation of absolute position of a localized state.

SPS measurements were performed in air using commercial Kelvin probe arrangement (Besocke Delta Phi, Jülich, Germany) with a sensitivity of ˜1 meV. The vibrating metallic probe consisted of a 2.5 mm diameter semitransparent gold grid mounted at a piezoelectric actuator. The probe was placed in close proximity to the ceramic sample surface. The piezoelectric crystal was moved by an external oscillator at a frequency of 170 Hz. The sample was illuminated by a 250 W tungsten-halogen lamp using a grating monochromator (Jarrell Ash). A value of the contact potential difference (CPD) and its changes with photon energy were measured using lock-in amplifier (LIA) and were processed by a Pentium 3 computer.

FIG. 11 illustrates an AF M image of HAP ceramics topography. Both sorts of the prepared ceramics “A” and “P” showed identical topographic features. Statistical analysis gave the average size of ceramic grains to be around 300 nm with a dispersion of 100 nm. The porosity of the fabricated samples was characterized by the use of scanning probe microscopy software and was found to be around 20%. No differences were found between “A” and “P” ceramic samples in DC conductivity measurements which showed the value around 10-8 Ω⁻¹cm⁻¹.

Composition and atomic concentrations of the elements contained in the investigated ceramics were determined by XPS and pH measurements. A typical formula for HAP is Ca10−x(HPO4)x(PO4)6−x(OH)2−x, where X ranges from 0 to 2, giving a Ca/P atomic ratio of between 1.33 and 1.67. The Ca/P molar ratio of studied ceramics obtained from XPS measurements was found to be 1.31 (“A”) and 1.54 (“P”) and it was related to low stoichiometric composition.

The pronounced composition difference observed between “A” and “P” ceramic samples was a result of concentration of free hydroxyl-ions (OH)—. It was found that the free (OH)— concentration in the “A” samples was smaller by a factor 2 than those in the “P” samples. The sample “A” also contained some impurities such as Na, Mg and Ba at a level of about 1% which were not resolved in sample “P”.

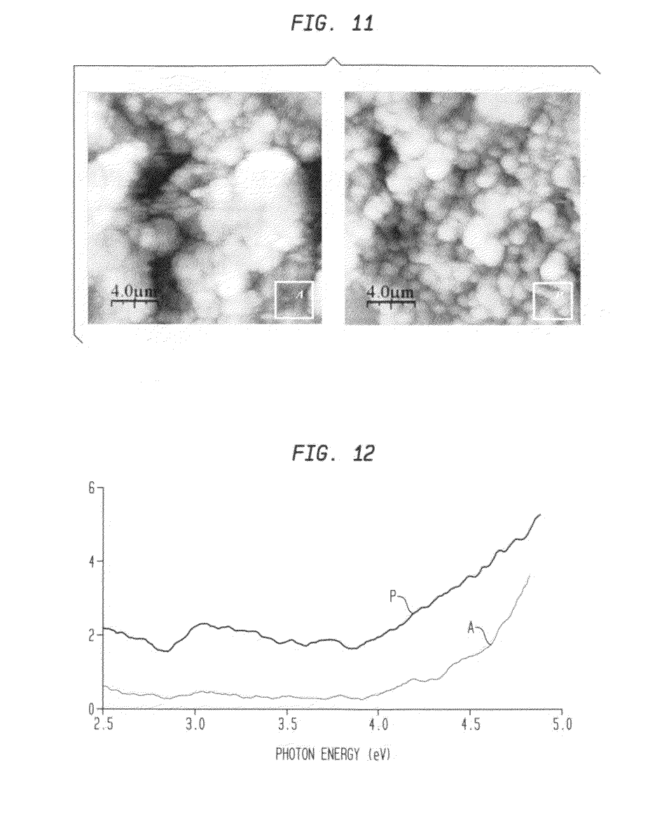

The basic optical data were measured by means of excitation spectrum of photoluminescence (PL). First, spectral emission region of PL was evaluated. Excitation of HAP ceramics by photon energy of 3.44 eV led to a very wide, continuous optical emission PL spectrum with a wide plateau in the range 540-680 nm. The excitation spectra, shown in FIG. 12, were measured in the region (2.5-6.2) eV using emission band 640±5 nm determined from the plateau of the emission spectrum.

It should be noted that both sorts of samples “A” and “P” showed very similar spectra but the intensity of PL differed substantially. The continuous increase of PL intensity was observed starting from the exciting photon energy of ˜3.8 eV. This excitation spectrum behavior in this spectrum region was a firm evidence of the fundamental absorption (inter-band transitions). The fitting of the edge of fundamental optical absorption allowed evaluation of the width of the forbidden band Eg in HAP ceramics for both “A” and “P” samples between E_{g}=3.8-4.0 eV. The measured spectra represented a wide non-symmetric. non-monotonic optical band. This could be accounted for by the number of localized energy levels of electron/hole origin. They were resolved into individual Gaussian components. The energies of these components are shown in Table 1. The deconvolution treatment of the experimental data allowed an exact value of the energy band gap E_{g}=3.95 eV to be obtained.

TABLE 1
Energy structure of electron (hole) states in Hydroxyapatite
obtained from Photoluminescence excitation spectra.

| Sample | | | | | | |
|---|---|---|---|---|---|---|
| Type | E₁ [eV] | E₂ [eV] | E₃ [eV] | E₄ [eV] | E₆ [eV] | E_{g} [eV] |
| A | 2.63 | 2.84 | 3.03 | 3.17 | 3.41 | 3.95 |
| P | 2.61 | 2.91 | 3.02 | 3.17 | 3.34 | 3.97 |

As may be noted from Table 1, several individual energy states were found to be located in the energy gap in the range of 2.6 and 3.9 eV. Both the excitation spectra (shown in FIG. 12) and deconvoluted data of Table 1 showed that samples “A” and “P” had very similar energy band and localized states energies. However, the observed strong difference in PL intensity pointed to significant difference in the states concentration.

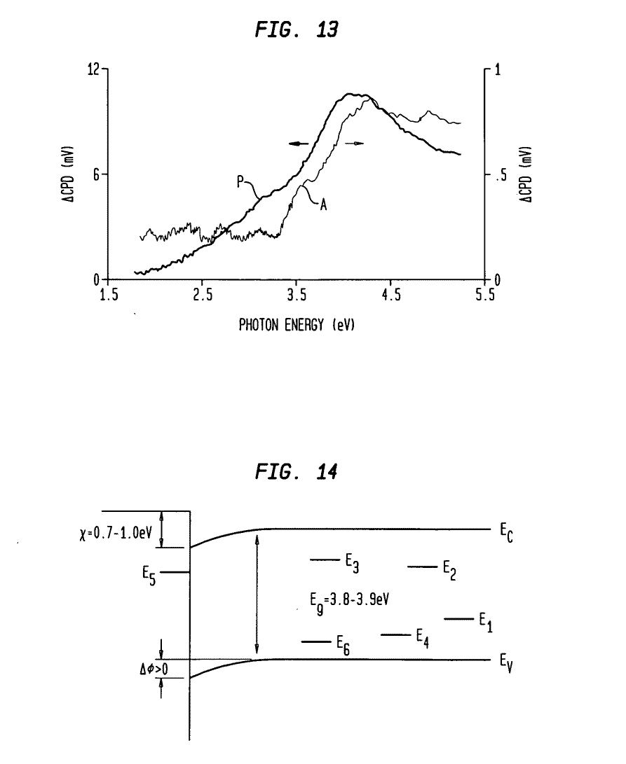

FIG. 13 shows a light induced variation of contact potential difference, ΔCPD. The ΔCPD spectra of both investigated HAP ceramics samples (“A” and “P”) were identical. Since light illumination typically tends to decrease the surface band-bending, this should result in a positive ΔCPD in P-type samples and a negative ΔCPD in N-type samples. The obtained ΔCPD spectra demonstrated a positive sign of the ΔCPD “knee” which allowed relating both HAP samples to P-type. Despite a very similar structure of ΔCPD spectra a pronounced difference was found for absolute values of ΔCPD which was 10 times higher for the “P” sample.

Another basic application of SPS is measurements of a sample band gap E_{g} and energy position of localized states. Strong monotonic variation of ΔCPD (shown in FIG. 13) occurred due to increase of light absorption coefficient near the band gap energy edge which was observed around 3.6-4.0 eV. According to the developed technique of ΔCPD curves treatment the sharpest change in the slope of ΔCPD was related to the region of the fundamental light absorption. As a result the value of the energy gap in HAP was determined as E_{g}=3.94 eV (Table 1) which was consistent with the E_{g} value obtained from the PL data (FIG. 12).

An identical approach was applied to estimation of energy positions of bulk and surface electron (hole) states. Excitation of electrons from bulk or surface states to the conduction band typically contributes to a positive change in the surface charge and hence a negative ΔCPD was expected. Conversely, excitation of holes to the valence band makes the surface charge more negative and positive ΔCPD should thus be observed. The combination of the ΔCPD threshold energy and the slope sign allows finding the absolute energy positions of bulk and surface states. They are determined as tangents intersection of a slope change points at ΔCPD curves.

Table 2 concentrates the estimated bulk and surface states energies for both HAP samples that were obtained from the ΔCPD data (FIG. 13). The determined energy of the six localized states were found to be in the range of 2.6 and 3.3 eV. Three of the six states were related to hole centers and the other three to electron centers, as shown in Table 3.

TABLE 2
Energy structure of electron (hole) states in Hydroxyapatite
measured by Surface Photovoltage Spectroscopy method.

| Sample | E₁ | | | | | | |
|---|---|---|---|---|---|---|---|
| Type | [eV] | E₂ [eV] | E₃ [eV] | E₄ [eV] | E₅ [eV] | E₆ [eV] | E_{g} [eV] |
| A | 2.64 | 2.82 | 2.99 | 3.17 | 3.30 | 3.43 | 3.94 |
| P | 2.61 | 2.87 | 3.00 | 3.17 | 3.24 | 3.35 | 3.86 |

TABLE 3
Energy positions of localized states in Hydroxyapatite

| Sample Type | E₁ [eV] | E₂ [eV] | E₃ [eV] | E₄ [eV] | E₅ [eV] | E₆ [eV] |
|---|---|---|---|---|---|---|
| A | E_{C} − 2.64 | E_{V} + 2.82 | E_{V} + 2.99 | E_{C} − 3.17 | E_{V} + 3.30 | E_{C} − 3.43 |
| P | E_{C} − 2.61 | E_{V} + 2.87 | E_{V} + 3.00 | E_{C} − 3.17 | E_{V} + 3.24 | E_{C} − 3.35 |

Comparison between the ΔCPD (FIG. 13 and Table 2) and the PL spectra (FIG. 12 and Table 1) indicated that the energy spectra of electron-hole levels studied by two different experimental spectroscopy techniques were very similar. However, the electron state E₅=(3.24-3.30) eV found by the SPS method was not observed in PL spectrum. Contact potential difference generated between the Kelvin probe and the illuminated sample surface was affected both by surface and near surface-bulk states. However, the PL intensity totally depended on the number of states participating in the recombination process resulting in photon emission. PL was mainly contributed by bulk states. It allowed relating the electron state E₅ to the surface state, which did not contribute sufficiently to PL. The photoelectron emission method was also applied for estimation of electron affinity of HAP. The measured value of electron affinity χ was found to be 0.7-1.0 eV. The electron energy structure of the studied HAP ceramics is demonstrated in FIG. 14.

SPS measurements showed that HAP was a P-type semiconductor. In accordance with the basics of semiconductor physics the electron energy of a semiconductor is varied near the surface because of occupation of surface states by majority charge carriers from semiconductor bulk states. The resulting surface potential changes and was observed as a band bending Δφ. For the P-type semiconductors, the surface potential Δφ was positive.

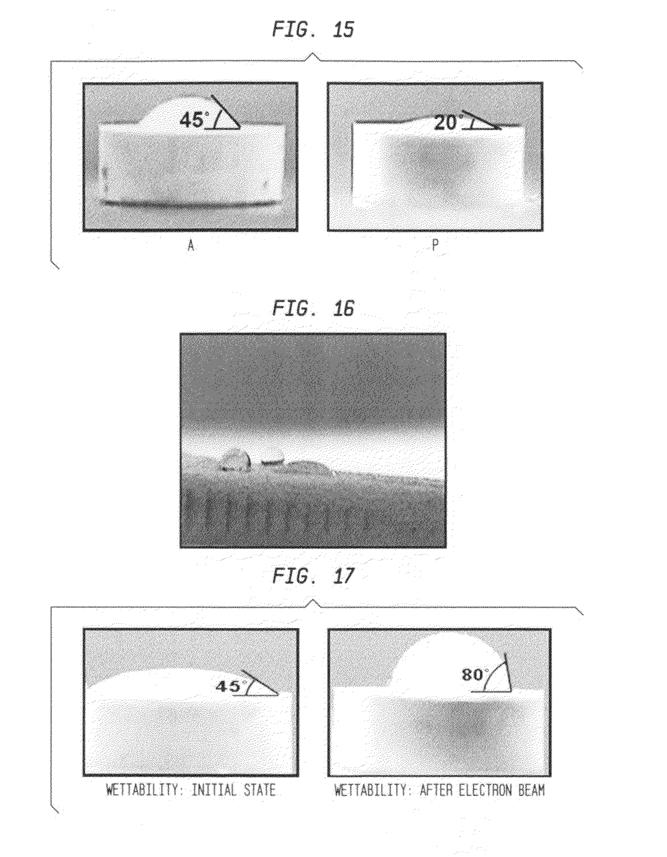

According to the physical origin of wettability, decreasing of the surface potential should lead to increasing of hydrophobicity of material surface. The experimental studies of the “A” and “P” HAP samples showed (FIG. 15) that the contact angle of the untreated HAP samples was 20° for “P” and 45° for “A” sample.

The picture of FIG. 16 demonstrates that the wettability properties of an untreated implant are highly inhomogeneous. Water droplets deposited on the implant surface exhibited two hydrophobic regions and one hydrophilic region.

The properties relating to the surface energy modification method of the invention permits surface charge modification by several techniques such as electromagnetic radiation or/and low energy electron irradiation, etc. The parameters, such as electromagnetic radiation wavelength, intensity, duration and direction of propagation and/or electron energy, electron current density, time exposition, direction of electron beam propagation are co-adapted to each material, so the majority of the incident (photon, electron) particles are absorbed in the surface layer, thus modifying the occupation of surface states and resulting in variation of surface potential and/or surface energy without affecting the defect structure or phase state of material.

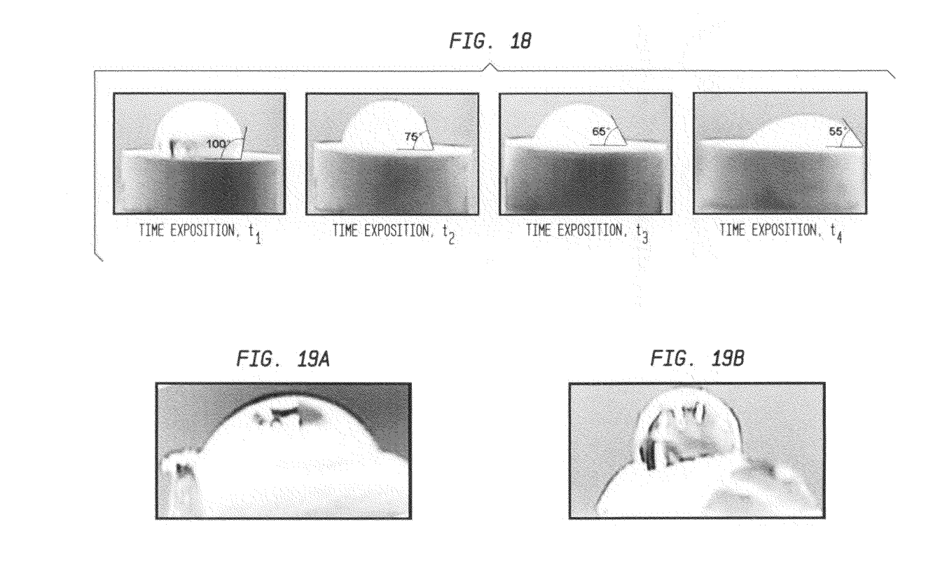

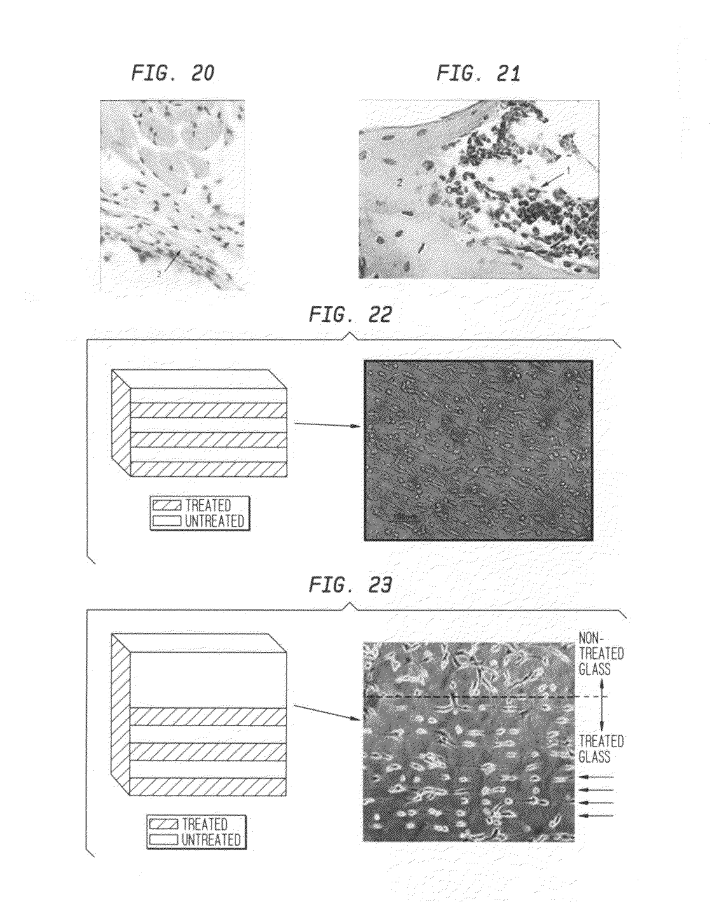

To modify the surface potential an effectively absorbed low energy electron beam was applied onto the thin surface layer. To locate the electron irradiated region inside the HAP surface layer which was the depth of depleted region (region of band bending), the electron energy in this case was estimated as Eₚ<100 eV which provided the region of the electron excitation at the depth below 10 Å. The calculations performed by the use of the Monte-Carlo method were consistent with the analytical solution. The experiment was performed in vacuum at 10⁻⁶ Torr using electron flux (Jₚ=300 nA/cm²) with varying durations of the electron exposition. As FIG. 17 shows electron beam irradiation afforded the transition of HAP ceramics from hydrophilic to hydrophobic states by exposing the HAP surface to low energy electrons over a period of 10 minutes. The initial contact angle 10-50° was changed to 80-120°. Compared to the heat radiation version of wettability modification the electron beam method also allowed the wettability to be changed gradually by variation of electron charge absorbed in the surface layer. The electron beam method also allowed the wettability to be changed gradually with accuracy of ±5° by variation of incident electron charge in the surface layer. This was performed by varying the time exposition of the irradiated sample in the range of t=2-10 minutes, as demonstrated in FIG. 18. It should be mentioned that thermal radiation of the electron irradiated HAP samples resulted in increasing of positive charge located at the surface states E₅. The surface potential increase led to conversion of hydrophobic state to the hydrophilic state.

The developed method was also used for wettability modification of commercially available medical implant (hip implant), as shown in FIGS. 19A and B. The electron energy was Eₚ=100 eV, electron current density was Jₚ=100 nA/cm², exposition time was varied in the range of 0-50 min, and under vacuum condition of 10⁻⁶ Torr. The contact angle was switched from 30° to 100°.

The adequate experimental approach to define possible osteogenous properties of hydroxyapatite is the variant of the entopic bone formation phenomenon when the artificial sample is implanted under a skin or intramuscularly without using growth factors.

In-vivo experiments were conducted. In our experiments CBA/CaLac mice were used. The stomach skin of the animals was cut under ether narcosis and the implant with a column of singenous bone brain which has been applied preliminary in aseptic conditions (on 1 hybrid implant on a mouse) was implanted subcutaneous. In 1.5 months the implants have been explanted and photographed in reflected light with the fixed parameters. The quantitative morphometry of digital images was carried out according to grey level statistics before and after implantation. To carry out the histological analysis the standard methods of light microscopy of thin section was used. After decalcination of tissue plates, grown on the implants, a usual painting of the paraffin section, made perpendicularly to a disk surface with gematoxylyn-eosin was carried out.

As the samples to be researched the disks from the titanium alloy (diameter 12 mm, thickness up to 1 mm) with various technologies of applying of calcium phosphates coatings were used. Some from them in addition were irradiated to change their physical surface properties.

Untreated calcium phosphates coatings made from nano-dimensioned HAP of the various nature (synthetic or biological), irrespective of technology of their applying have slightly marked ability to induce growth of bone tissue on the surface. The probability of bone plate formation is 33%. In other cases the loose nonformed vascularized connecting tissue grows from a bone marrow.

On the other hand, additional low-energy electron irradiation of the same calcium phosphate surfaces in a “low” mode results to 100% output of bone tissue. Apparently, the “high” level of electron irradiation of the surfaces has similar effect; too, however, the very thin tissue plates are formed, which do not allow obtaining histological sections.

In such a way, the proposed method of low-energy electron irradiation of the calcium phosphates surfaces applied from nanodimension hydroxyapatite of the various nature (synthetic or biological), irrespective of technology of their applying stimulates frequency (probability) of formation of a bone tissue in the ectopic subcutaneous osteogenesis test on the average on 67%.

In addition, different cells patterning (alignment) was demonstrated on the surfaces prepared by the developed method, using electron irradiation and/or combination of the later with electromagnetic radiation,shows fibroblast cells patterning on preliminary stripped glass substrate, using irradiation by electrons with electron energy Eₚ=350 eV and electron incident charge Q=200 μC/cm².

FIG. 23 shows stem cells patterning on preliminary stripped glass substrate, using irradiation by electrons with electron energy Eₚ=350 eV and electron incident charge Q=200 μC/cm². It is clearly seen that there is no cells alignment on untreated region.

Adhesion of biological cells and microorganisms to surfaces and inhibition of growth processes on such surfaces provide valuable information on biomimetic substrate behavior utilized for tissue engineering. In order to understand the biocompatibility of for example nanostructured modified HAP and related calcium phosphate based scaffolds, the adhesion of basic biological macromolecules such as proteins and deoxyribonucleic acid (DNA) towards such materials was examined. The surface modification was performed by electron irradiation (the electron energy was 500 eV, electron current density 100 nA/cm², exposition time was varied in the range 0-50 min, vacuum—10⁻⁶ Torr).

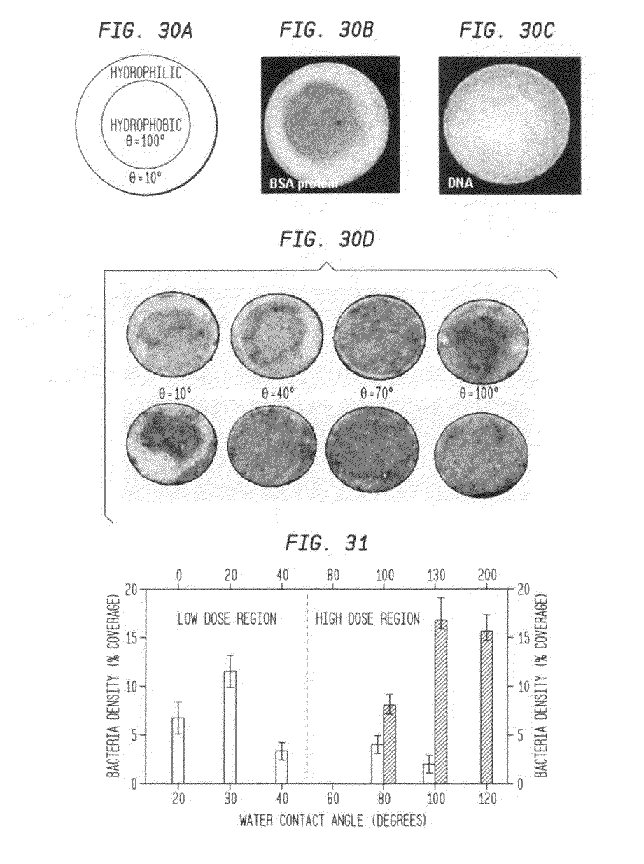

As FIGS. 30A-C show the differences in wettability resulted in a differential binding of biological molecules, in correlation to their level of hydrophobicity. DNA, for example, being a very hydrophilic molecule due to the phosphate groups in the sugar-phosphate backbone, bound preferentially to the high wettability surface (high hydrophilicity). In contrast, the binding of bovine serum albumin (BSA), a protein that contains hydrophobic domains was more pronounced at low wettability regions (high hydrophobicity).

Among various types of surface interactions the origin of proteins adhesion on biomaterial surface in orthopedic implants and engineered tissues is mainly ascribed to wettability of the biological substrates considering hydrophobic/hydrophilic properties as a leading mechanism responsible for the cells immobilization. Experimental evidences suggest that the hydrophobic interaction is the major determinant of protein adsorption, whilst DNA prefers the more hydrophilic substrates. The observed tunable wettability modulation in the wide range of the contact angles allows engineering of any wettability state needed for adhesion of biological cells.

Biological materials with different surface properties, such as BSA and DNA, were used to confirm the wettability modification of the irradiated HAP surface. BSA and single stranded salmon sperm DNA (Sigma-Aldrich Corporation, St. Louis, Mo., USA) were dissolved in distilled water at a concentration of 1 mg/ml and applied to the irradiated HAp ceramic surface (the volume of the solution was 100 ml). Since the DNA and BSA concentration was quiet low the pH was that of the water (˜5.5). The samples were incubated 15 min at room temperature with no vibrations, washed several times with distilled water and then Giemsa stained (Sigma-Aldrich Corporation) to visualize the biomolecules.

The wettability of the series of the hydroxyapatite samples was tailored in the range of. θ=10° to θ=100°. FIG. 30D illustrates that the variation of the hydroxyapatite wettability results in selective adhesion of the biological molecules, such as BSA and DNA. The obtained results are highly reproducible after each repetitive experimental cycle, which included electron irradiation and molecules binding. The differences in wettability resulted in differential binding of biological molecules, in correlation to their level of hydrophobicity. Thus, DNA, a very hydrophilic molecule due to the phosphate groups in the sugar-phosphate backbone, bound preferentially to the high wettability surface (θ<50°) (FIG. 30D, bottom row).

In contrast, the binding of BSA, a protein which contains hydrophobic domains was more pronounced at low wettability (θ>50°) (FIG. 30D, top row). In the case of a hydrophobic surface, water molecules are ordered in an ice-like structure at the surface and have much lower entropy than the water molecules in the bulk. The interaction between a hydrophobic surface and a protein originates mainly from an entropy gain due to water desorption from the solid surface and from the protein molecule. In contrast, water molecules near to a hydrophilic surface exhibit relatively more-dense water structure in an extended three-dimension network of self-associating molecules. This type of water structure is less reactive and therefore it is difficult to be removed. To hydrophilic surfaces, the proteins are adsorbed weakly with a conformation near to their native state. As a result the protein adsorption to hydrophilic substrata is generally reversible, whereas to hydrophobic one's it is not.

Development of biomaterials, inherently resistant to bacterial adhesion and growth, is a key challenge in the field of medical implants. Analysis of numerous publications presented in the review papers shows that bacterial adhesion is mediated by a large variety of biological processes and critically depends on the bacterial-biomaterial interface properties. The susceptibility of biomaterials to bacterial adhesion is determined by several factors related to surface properties, such as the chemical composition of the surface, fine surface topography, roughness, surface electric charge and wettability state. Among the various physical properties of material substrates influencing bacterial adhesion, wettability and electric charge are likely to be the leading factors.

The research of bacterial adhesion and its significance is a large field covering different aspects of nature and human life, such as marine science, soil and plant ecology, the food industry, and most importantly, the biomedical field. Adhesion of bacteria to human tissue surfaces and implanted biomaterial surfaces is an important step in the terms are defined based on the literature. Bacterial adherence to surfaces is not fully understood. In general, it is influenced by many factors, such as the growth medium, the age of the culture, the physiological state, and the cell surface. In general, hydrophobic bacteria adhere on hydrophobic surfaces, whereas hydrophilic ones prefer hydrophilic surfaces. Thus, adjusting substrate wettability, which affects the hydrophobicity, is expected to affect bacterial adherence and can also be a key for understanding bacterial interaction with material surfaces. Such a modification of the surface wettability may open the avenue for protection of implanted scaffolds from bacterial infections.

Surface modification was performed by the developed electron irradiation of the preliminary cleaned implant samples. To locate the electron irradiated region inside the HAP surface layer which is the depth of depleted region (region of band bending), the electron energy was estimated around Eₚ˜100 eV, which provides the region of the electron excitation at the depth about 20 Å. The calculations of the electron penetration performed by the use of the Monte-Carlo method were consisted with analytical solution. The incident charge Q was varied, ranging from 0 to 200 μC/cm², to fabricate the required surface wettability state.

As model bacteria, Escherichia coli (E. coli), Pseudomonas putida (P. putida), and Bacillus subtilis (B. subtilis) were used. The bacteria were grown at 37° C. with vigorous agitation in the standard LB medium (LB Broth, Lennox, Difco), which is a rich growth medium that contains all the nutritional requirements for the three bacterial strains. Growth was for 14-16 hours and during this time period all the bacteria reached stationary phase, around 10⁹ bacteria per ml.

The full results of immobilization on fabricated HAP samples are summarized in Table 4. The experimental results on adhesion of the bacteria showed that the distribution of the E. coli adhesion was distinctly selective on the HAP surface around a contact angle of θ˜30°.

TABLE 4
Adhesion of various bacteria on the hydroxyapatite surface as a
function of wettability modulation (θ is the contact angle).

| | θ = | | θ = | | θ = | | |
|---|---|---|---|---|---|---|---|
| | 10° | θ = 20° | 30° | θ = 40° | 60° | θ = 80° | θ = 100° |
| E. coli | − | ± | + | ± | − | − | − |
| P. putida | − | − | − | − | − | + | ± |
| B. subtilis | − | − | − | − | − | ± | + |

The symbols +, −, ± represent bacterial adhesion, no adhesion and intermediate reaction, respectively.

Adhesion of the B. subtilis was observed at the hydrophobic HAP substrate state starting from the contact angle of θ˜80° and increased its adhesive affinity with the increasing of the contact angle up to θ˜100°. The P. putida bacteria demonstrated a different behavior. Its adhesion showed a maximum for θ˜80° and then gradually reduced with the increasing hydrophobicity. The selective adhesion may be related to different bacterial hydrophobicity and as a result to the tendency of the bacteria to a certain surface having a certain hydropibicity. This effect may be used in a vast selection of applications ranging from analytical to medical.

FIG. 31 illustrates that the variation of the HAP wettability results in selective adhesion of the three different bacteria, B. subtilis, E. coli, and P. putida. The distribution of the relative bacterial adhesion of the E. coli, B. subtilis, and P. putida was distinctly selective for the irradiated hydroxyapatite surface. These bacteria were chosen to represent a Gram positive (B. subtilis,) and two commonly used Gram negative bacteria (E. coli and P. putida) which vary in outer surface properties (flagellation and lipopolysaccharide). In order to have a reproducible system, in which the three bacterial cultures can be observed in the same physiological state, and because these bacteria vary in their generation time, it was decided to use cultures grown to the stationary phase. The data indicate that binding of the Gram-negative E. coli is observed only in the low dose region (Q<50 μC/cm²), around θ˜30°, whilst another two bacteria, Gram-negative P. putida and Gram-positive B. subtilis adhered at the high dose region (Q>50 μC/cm²), possessing maximum of relative bacterial adhesion at θ˜80° and θ˜100-120°, respectively. The results were highly reproducible and indicate that the selective adhesion may be related to different bacterial hydrophobicity.

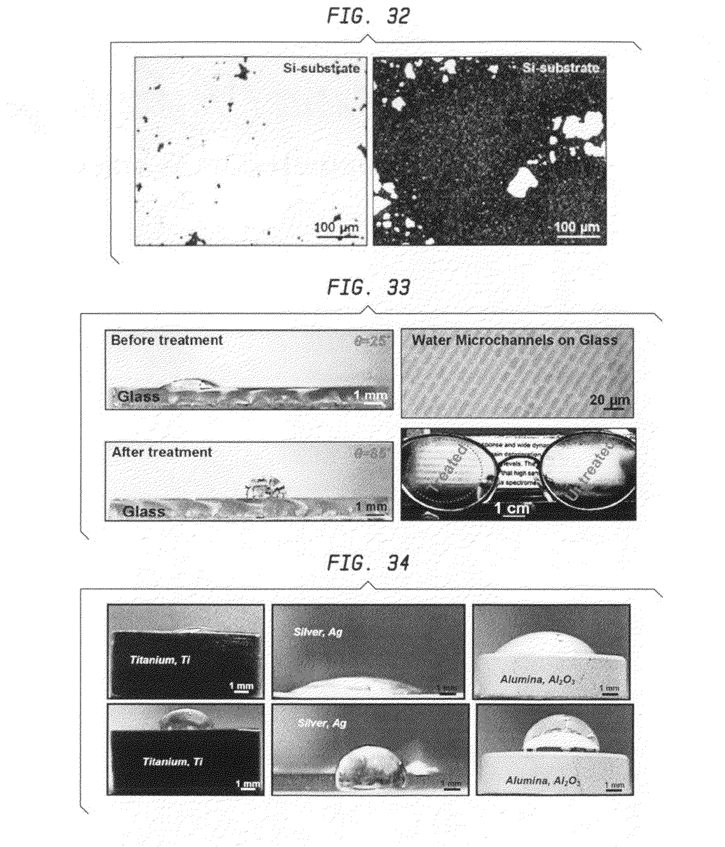

The developed method of surface properties modification allowed also the fabrication of a device (substrate) with varying affinities to viable and non-viable baker's yeast. The fabricated device can be used in recognition of viable/non-viable yeast. FIG. 32 demonstrates different affinities of the untreated Si (FIG. 32 left picture, non-adhesive state) and electron. irradiated Si substrate (FIG. 32, right picture, yeast-adhesive state). The irradiation was performed by electrons with energy Eₚ=100 eV, when electron incident charge was Q=300 μc/cm².

The developed methods of the invention also allow to strongly modifying the wettability of amorphous materials such as glass. FIG. 33 demonstrates the result of electron beam charging of glass material. Irradiating glass material with an electron beam led to a pronounced variation in wettability in a very wide range. The electron energy was Eₚ=120 eV, electron current density was Jₚ=100 nA/cm², exposition time was varied in the range of t=0-20 min, and vacuum was of 10⁻⁶ Torr.

Applications to Silicon Oxide and other Inorganic Surfaces

The method of the invention similarly enables the achievement of tunable wettability (hydrophobicity) of other surfaces such as silicon-based materials in a wide range of contact angles, θ, from 10° to 120°, with accuracy of ±5°. The electron energy was 500 eV, electron current density was 10 nA/cm², exposition time was varied in the range of 0-210 min and the vacuum conditions were 10⁻⁶ Torr.

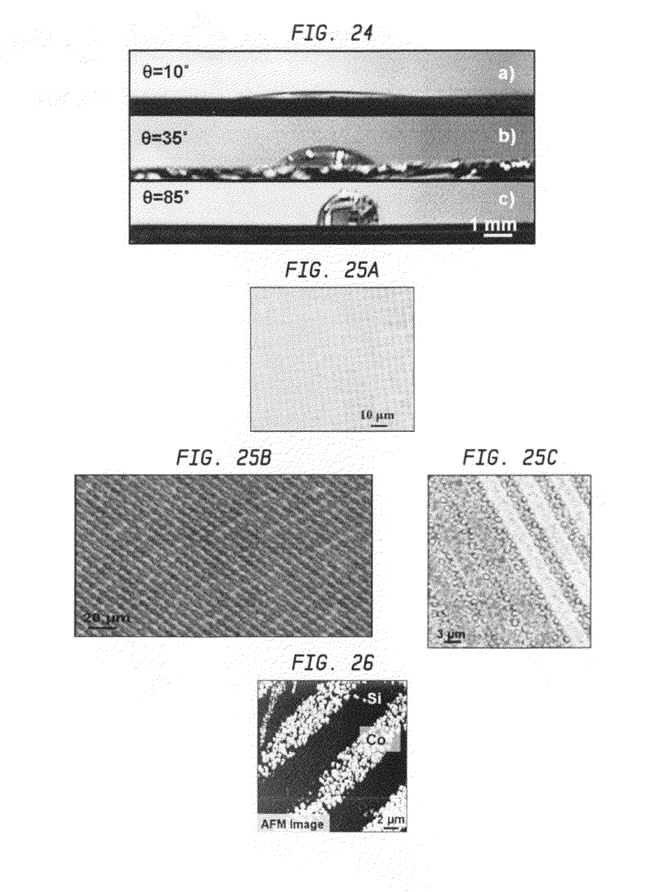

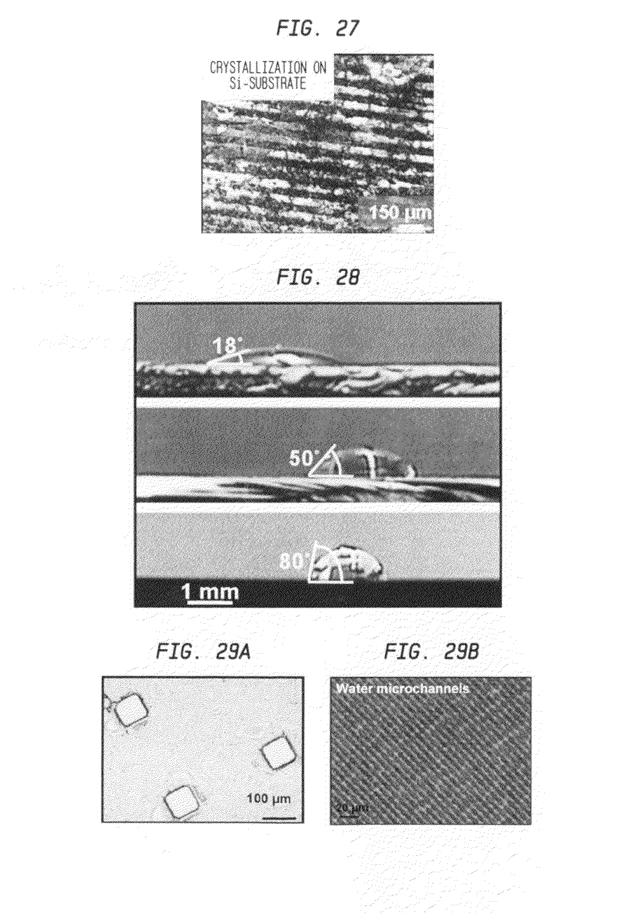

As FIG. 24 demonstrates tunable hydrophobicity of Si substrate, without chemical or mechanical treatments of the surface, was possible. This method (using electron energy of 1000 eV, electron current density of 100 nA/cm², exposition time varied in the range 20 min, and vacuum of 10⁻⁶ Torr) further allowed the fabrication of patterned one-dimensional or two, three-dimensional patterns on the Si surfaces, which could be used as water matrices as shown in FIG. 25A and water microchannels as shown in FIG. 25B, as a patterned substrate for the deposition of different metals, as shown in FIG. 26 for the electroless deposition of Co on the un-irradiated portions of the substrate, or for the crystallization of various materials, as shown in FIG. 27 for the exemplary crystallization of Na₂CO₃ on the unirradiated portions of the Si substrate.

FIG. 25C presents electron-induced patterning of SiO₂ surface with three different levels of wettability providing sharp contrast of wetting. Open-air water microchannels were fabricated on the SiO₂ surface with different degrees of wettability, induced by variation of the incident charge density Q (the incident electron energy is Eₚ=100 eV). The patterned surface was exposed to a water vapor at a 50% RH. After cooling to a temperature of 5° C. below the dew point, the water condensed on the hydrophilic regions, producing liquid microchannels. Large drops are associated with hydrophilic (untreated) region, whereas dark and bright areas, with no visible drops, are referred to the hydrophobic regions for Q=0.10 and 2 μC/cm², respectively. The tailored microchannels of 3 μm width are homogeneous and shaped as cylinder segments with a constant cross section.

It should be noted that the presented data also indicates that the proposed method allows removing moisture (dewetting effect) and fabricating the patterned surface structure with modulated moisture.

The achievable tunability of hydrophobicity of silicon oxide surface was demonstrated above. As FIG. 28 demonstrates tunable hydrophobicity of SiO₂ substrate, without chemical or mechanical treatments of the surface was also achievable (The electron energy was 500 eV, electron current density was 10 nA/cm², exposition time was varied in the range of 0-210 min, and vacuum was of 10⁻⁶ Torr). This allowed fabricating wettability micropatterned surfaces such isolated water (liquid) drops, water (liquid) matrices (FIG. 29A) and water (liquid) microchannels (FIG. 29B) on silicon oxide surfaces.

Other amorphous materials such as silicon nitride, silica, fused silica, etc and dielectric crystalline materials such as Al₂O₃, and mica, which were subjected to the electron beam irradiation showed similar wettability modification. The irradiation conditions were adapted to each material when the electron energy was varied in a range of Eₚ=10-1000 eV, electron current density was about Jₚ=10-300 nA/cm², exposition time was varied in the range of t=0-210 min, and vacuum was 10⁻⁶ Torr. The adaptation means that low energy electron irradiation does not lead to any damage, creation of defects, chemical decomposition, phase state of the material, as described herein.

As may be known to a person skilled in the art, ferroelectrics are polar dielectrics possessing spontaneous electrical polarization without application of electric field. The polar faces of ferroelectric crystal LiTaO₃ were treated using combination of electron beam irradiation and UV radiation allowing variation of the wettability of the crystal in the range 6°-90°. Both faces showed the same contact angles after the treatment. The electron energy was Eₚ=300 eV, electron current density was Jₚ=100 nA/cm², exposition time was varied in the range of t=0-10 min., and vacuum was 10⁻⁶ Torr.

Different types of metals and metal oxides such as Ti, Ag, Al₂O₃, etc, were also tested. All of them showed strong variation of the surface energy (wettability) after electron irradiation as shown in FIG. 34. The irradiation conditions were adopted to each material when the electron energy was varied Eₚ=10-1000 eV, electron current density Jₚ=10-300 nA/cm², exposition time was varied in the range t=0-210 min vacuum—10⁻⁶ Torr.

The method of the invention was also applied on paper specimens, which showed strong variation of the wettability parameters after electron irradiation (FIG. 35). This application allowed the improving of paper anti-wetting properties. The electron energy was 1000 eV, electron current density 200 nA/cm², exposition time was varied in the range 0-20 min, vacuum—10⁻⁶ Torr.

Thus, the present invention provides a novel wettability and other properties related to the surface energy modifying method and device that can be used in various applications. The invention provides for imprinting of the modified surface energy and related properties (wettability, adsorption, adhesion, friction, etc) with high resolution; for tailoring and tuning of the wettability state in a wide range of contact angles (10-120°), and for fabricating micro/nano patterned templates.

The electron-induced surface properties modification is reversible to its initial (untreated) state using, for example, UV light illumination. FIG. 36A shows wettability patterning on the SiO₂ surface using electron irradiated through a specially designed Si shadow mask. The mask contained arrays of circular holes of 100 μm in diameter and period of 200 μm. FIG. 36 B demonstrates wettability patterning on the SiO₂ surface performed by two-stage process. Preliminary, this process includes electron irradiation of the entire Si sample, resulting in a hydrophobic state all over the irradiated surface. The second stage followed by UV light illumination through the Si shadow mask, reversing the hydrophobic states to the initial, hydrophilic, state in the illuminated areas.

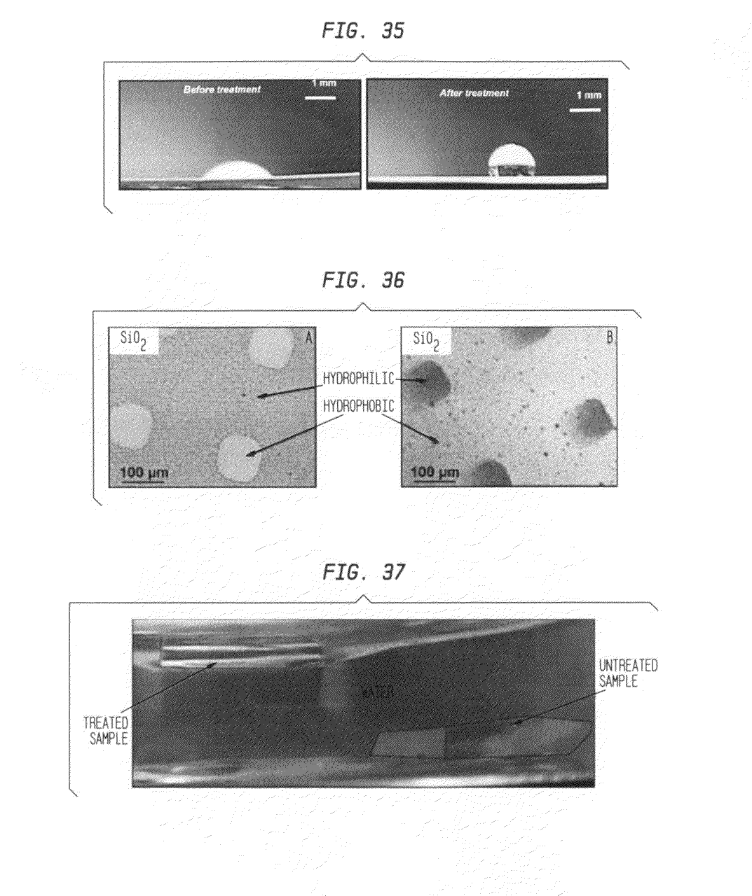

Applying the method of the invention to solid materials also allows controlling and modifying surface properties, such as floatation. FIG. 37 shows untreated glass sample sinking in water, and electron-irradiated glass of the same chemical composition floating over the surface.

Applications to Material Science

To change independently a len's numerical aperture, one needs to controllably change the angle of contact between the monomer solution and the surface, which is determined, among other parameters, by the surface energy of the substrate.

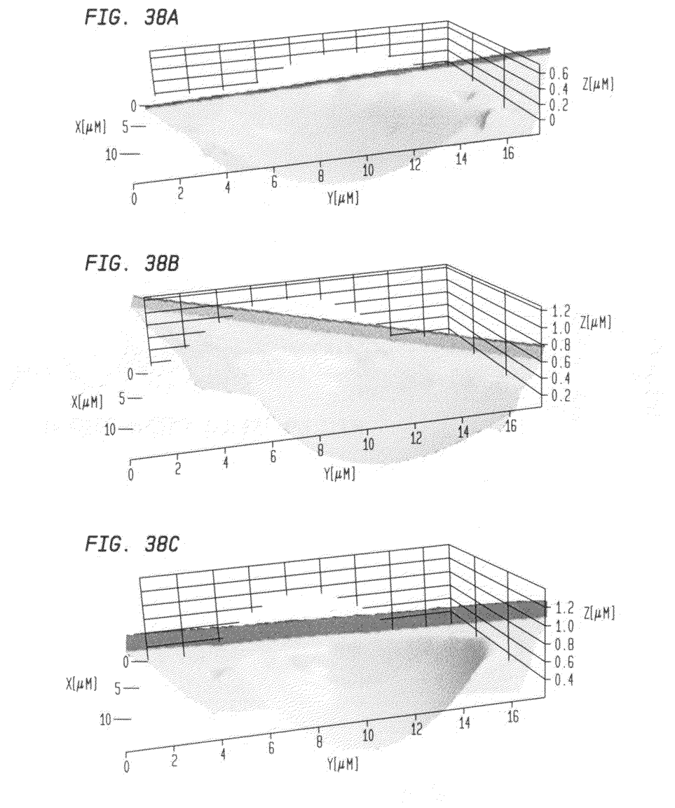

Glass slides were electron irradiated to produce three types of surfaces with Q=5, 50, and 120 μC/cm² incident surface charge densities, respectively. The micropipettes were used to deposit drops on all surfaces for various durations between 1 and 20 sec. The resulting lenses were investigated with AFM and bright-field microscopy to characterize their geometry and optical properties, respectively. AFM scans of the polymerized droplets reveal that they form smooth spherical caps, with root mean square roughness of 1.6 nm. The qualitative influence of the surface treatment is demonstrated in FIGS. 38A-C, which show a three-dimensional representation of three microlenses, all with the same deposition time (10 sec), manufactured on differently irradiated surfaces. It is readily visible that the lenses have a larger diameter and radius of curvature, and a decreasing contact angle, with increasing electron irradiation dose of the surface.

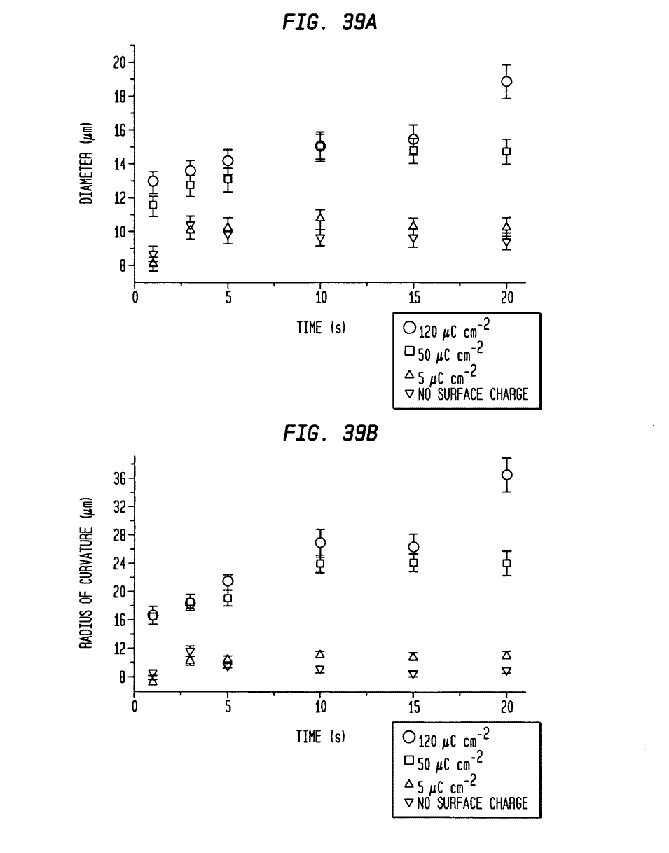

The quantitative effects of change in surface energy are shown in FIGS. 39A and 39B, which presents a summary of all the sets of lenses written on the three irradiated surfaces and one control surface (untreated). The dependence of the lens diameter on deposition time for each surface is plotted in FIG. 39A, and for each surface the lens diameter increases with deposition time in a nonlinear fashion, approaching an asymptotic value for long deposition times. For the same deposition time, increasing diameters are obtained for surfaces with higher incident surface charge density. FIG. 39B shows a plot of the AFM measured radius of curvature R of the lenses as a function of the deposition time. For a given surface, the contact angle is constant, giving rise to a linear dependence of R on the diameter D of the form:

$$R = \frac{D}{2 sin θ}$$

where θ is the contact angle. This explains the qualitatively similar behaviour of the plots describing the diameter and radius of curvature. Importantly, the radius of curvature depends on the diameter and thus, on the deposition time and also on the contact angle, which is changed by the irradiation of the surfaces. Using both parameters leads to the ability to modulate the radius of curvature by as much as 30 μm (from 8 to 38 μm).

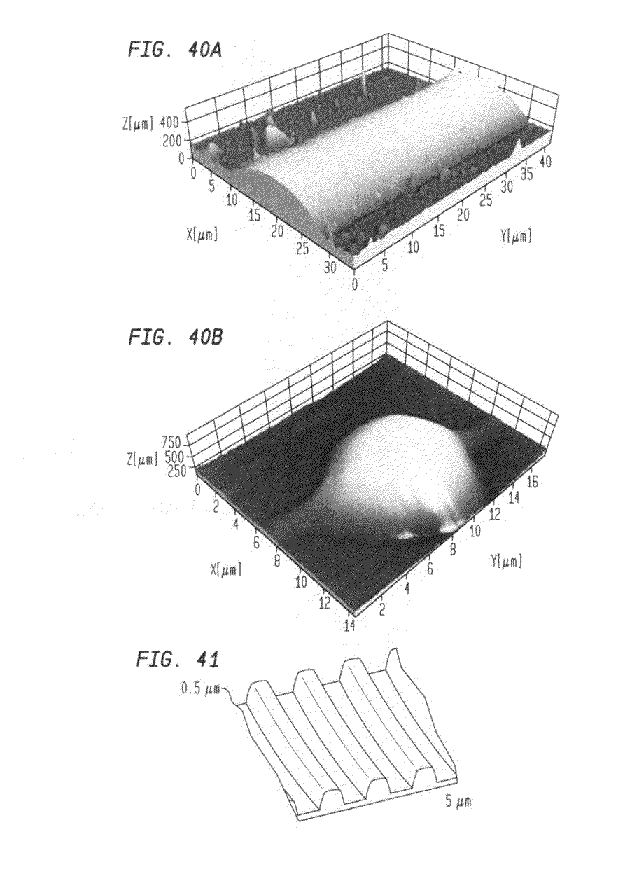

Using the same technique of surface modification, polymer fibers (channels) were tailored on the glass substrate as shown in FIGS. 40A and 40B. The polymer channel (FIG. 40A) exhibiting a single bulge (FIG. 40B) were achieved on preliminary patterned with electron beam glass substrates.

The method of the invention was also applied to photolithography process on Si. Both resist adhesion and profile contrast (FIG. 41), were improved by modifying the surface properties (energy) of a Si wafer by electron irradiation, without any additional chemical treatments.

TABLE 5
Comparison of photolithography properties on untreated
and electron irradiated Si surfaces.

| | Untreated | Irradiated |
|---|---|---|
| Height uniformity | 0.39-0.49 μm | 0.50-0.52 μm |
| Average height | 0.45 μm | 0.51 μm |
| Striping | high | low |

Experimental evidence showed that electron irradiation results in strong reduction of the polar component and increasing of the dispersive component of the surface free energy of the studied surfaces. It is well known that organic solvents, such as photoresist, have low surface free energy, when the major contribution to its surface energy is made by a dispersive component. Thus, due to the thermodynamic aspects, a more efficient wetting of the photoresist should be achieved on the electron irradiated substrate, which has higher dispersive component of the surface free energy.

A common approach for analysis of surface properties (surface free energy) is thermodynamics. The Owens-Wendt approaches provide information about various surface free energy components. The data obtained from detailed studies of Silicon DioxideError! Reference source not found. show that the electron irradiation strongly modifies the surface free energy of SiO₂ by decreasing its total surface free energy γₛᵥ value through all doses, almost twice from 70.3 to 40.4 mJ/m². However, variations of dispersive and polar surface components of surface free energy are quite different for the low and high dose regions.

TABLE 6
A summary of SiO₂ surface free energy
components (Owens-Wendt analysis).

| | | | Surface |
|---|---|---|---|
| Treatment dose | Polar component | Dispersive component | energy |
| Q (μC/cm²) | γₛᵥ^{p} (mJ/m²) | γₛᵥ^{d} (mJ/m²) | γₛᵥ (mJ/m²) |
| untreated | 31.4 | 38.9 | 70.3 |
| 0.15 | 27.5 | 38.7 | 66.4 |
| 150 | 0.4 | 40.0 | 40.4 |

The low dose region of the electron irradiation (Error! Reference source not found. Q<0.15 μC/cm²) is characterized by relatively weak reduction of the surface free energy from 70.3 to 66.4 mJ/m², when fraction relation γₛᵥ^{p}/γₛᵥ^{d} is decreased to 0.71. It occurs mainly due to variation of the polar γₛᵥ^{p} component from 31.4 to 27.5 mJ/m² while the dispersive component changes feebly. The most significant influence of the electron irradiation is observed in the high dose region (Error! Reference source not found, Q>150 μC/cm²) where the polar component strongly drops down to γₛᵥ^{p}˜0.4 mJ/m² and the dispersive component increases up to γₛᵥ^{d}=40.0 mJ/m². Such a significant material surface evolution gives rise to absolutely different surface properties of the modified SiO₂ where the fraction relation of γₛᵥ^{p}/γₛᵥ^{d} falls down to 0.01 in comparison to 0.81, found for the untreated SiO₂.

The obtained data allow fabrication of a device (substrate) with low polar and high dispersive components of the surface free energy. The fabricated device can be used in separation of liquids with different surface tensions, such water and oil. As Figs. demonstrates removing of oil drop from water by the use of SiO₂ substrate irradiated by electrons with energy Eₚ=100 eV, when electron incident charge was Q=300 μC/cm².

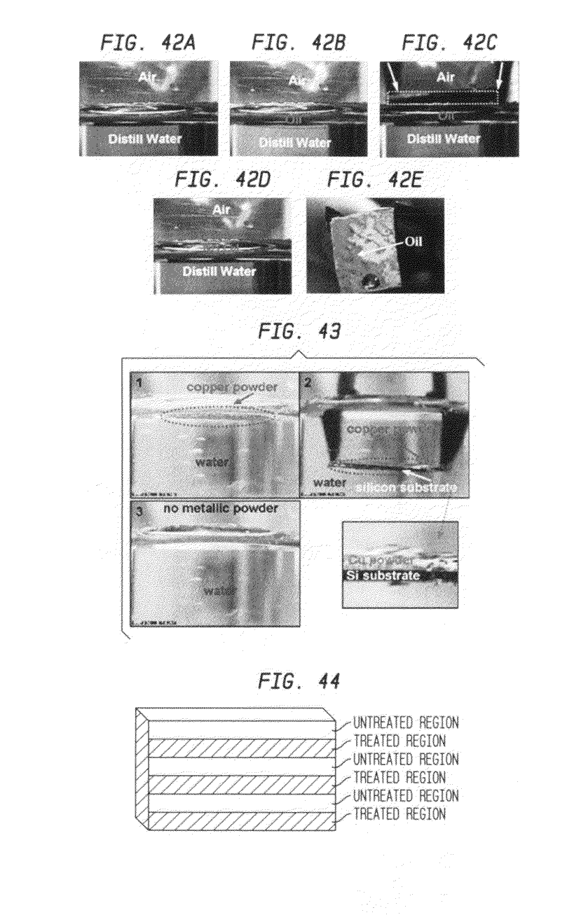

As FIGS. 42A-42E show, the surface properties of a SiO₂ surface may be modified in accordance with the present invention to enable the removal of oil from water.

As mentioned before, the method of the invention allows fabrication of a device (substrate) with various surface free energy componentsError! Reference source not found. The fabricated device can be used in extraction, for example, of metallic powder from liquid solution. FIG. 43 demonstrates the process of removing of Cu-powder from water by the use of Si substrate irradiated by electrons with energy Eₚ=100 eV, when electron incident charge was Q=300 μC/cm².

As it will be further shown below, by employing the method of the invention, also metal atoms and ions may be extracted from liquid solutions.

Additionally, the method of the invention allows selective adhesion of different metals, such as cobalt, Co; copper, Cu; palladium, Pd; and Aluminum, Al, on a preliminary patterned as schematically shown in FIG. 44. An example of such patterning was demonsteretd herein above in respect of FIG. 26.

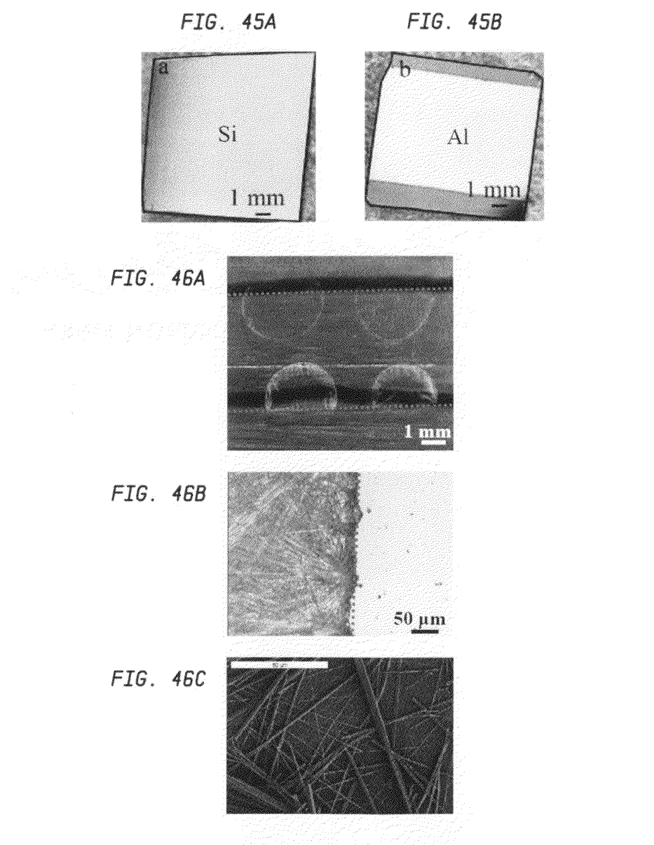

Using vacuum Al metal sputtering on Si substrate as demonstrated in FIG. 45A, did not allow for adhesion of Al on the low surface energy (hydrophobic, θ˜90°) Si substrate induced by electron beam irradiation. On the other hand, a good adhesion of Al was observed, as shown in FIG. 45B, on untreated hydrophilic (θ˜10°) Si substrate. This result is in accordance with principles of minimization of surface energy, i.e. the surface free energy of the film should be less than or very nearly equal to that of the substrate. Such an approach allows fabrication of free standing thin films.

Biomaterials

The method of the invention also allows peptide nanotubes patterning. In examples employing diphenylalanine peptides, the peptide was dissolved in fluorinated alcohol then diluted in water and self assembled to form nanotubes, this solution was deposited on the wettability modified Si and glass surfaces and allowed to dry at room temperature. The water based solution was drawn to the hydrophilic areas, while drying it allowed the deposition of the nanotubes only at the hydrophilic areas. Peptide nanotubes droplets were deposited on the stripe between the hydrophilic and the hydrophobic areas resulted in the formation of peptide nanotube pattern at the shape of half a circuit due to the repulsion of the solution from the hydrophobic area (FIG. 46A). Next we covered all the electron irradiated Si and glass specimens with the peptide nanotubes solution after the sample was dried a cover of horizontally deposited nanotube was observed only at the hydrophilic areas (FIGS. 46B and 46C). It should be mentioned that no significant difference were found between peptide nanotubes patterning on conductive Si and dielectric glass samples.

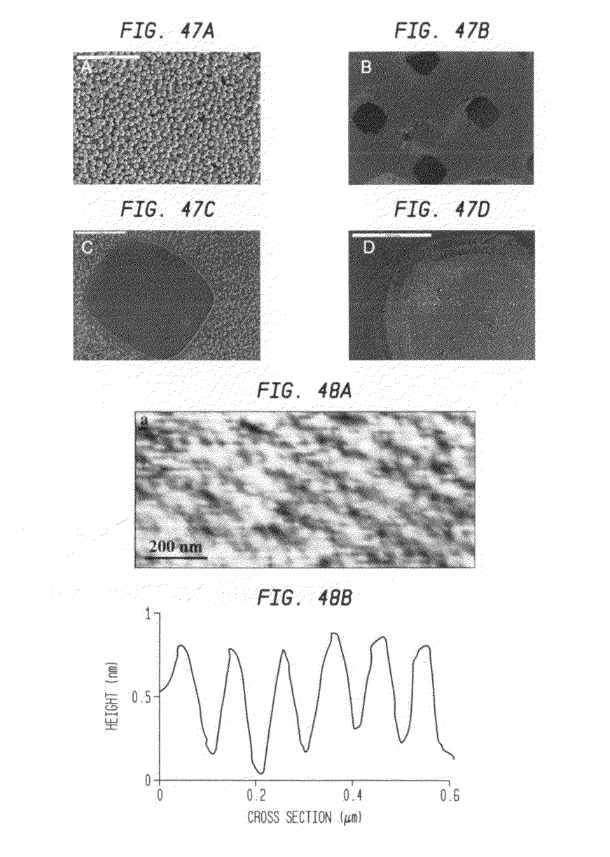

The wettability patterned surface was also used to control patterning of peptide nanospheres (FIG. 47A). The peptide nanospheres were self assembled by the amine modified analogue of diphenylalanine peptide the Boc-Phe-Phe-OH. The nanospheres solution was deposited on a wettability patterned surface containing array of 100 μm hydrophobic square. The surface high resolution wettability pattern was formed by exposing the Si and glass samples to local electron irradiation through a specifically designed Si-shadow mask. The nanospheres, similarly to the nanotubes were deposited only at the hydrophilic areas, which are in this case, outside of the 100 μm squares (FIGS. 47B and 47C). Here, also, as in described above peptide nanotube patterning, no preference between conductive Si and dielectric glass surfaces was observed.

In order to form a mirror image of the peptide nanospheres pattern, a 100 μm array of hydrophilic square was formed. It was previously shown that electromagnetic radiation such as UV illumination of the preliminary electron irradiated sample led to complete restoration of the wettability properties in the studied samples. Following this procedure, the nanospheres solution were deposited on the surface, this time the structure were withdrawn to the 100 μm squares and deposited on it (FIG. 47D). It should be mentioned that the same results were observed on both, Si and glass, substrates.

Surface Modified Layers

The present invention also provides an alternative approach for the formation of surface modified layers of materials using a low-energy electron beam without preliminary depositing self-assembled monolayers (SAMs) or using any other processes of the deposition of foreign materials, molecules, or atoms on the surface. The parameters of the electron irradiation (current density, electron energy and electron dose or time of exposition) are co-adapted to the physical properties of the material surface such as electron structure in the vicinity of the surface in order to avoid any defect generation in the irradiated material and variation of its basic intrinsic bulk properties. The electron-modified layer possesses quite different physical properties compared to the material bulk resulting in variation of basic intermolecular interaction at its interface. That leads to a deep modulation of key surface material properties. The method of formation of electron-induced surface modified layers may be applied to modification of many surface material properties such as catalytic activity, chemical reactivity, corrosion, etching, hygroscopicity, agglomeration, friction, bonding, etc and used in branches of technology where material surface encapsulation and coating with ultra-thin modified layers are needed.

This method was successfully applied by the inventors of the present invention in many crystalline, amorphous and powder materials, such as silicon-based materials such as SiO₂, Si₃N₄, n and p-Si; glass, mica, oxides such as Al₂O₃, ZnO, TiO₂, ferroelectrics (TCO, LiNbO₃, LiTaO₃), metals (Al, Ti, Cu, Ag and Zn), biomaterials (calcium phosphates, sea shells), and others. It should be mentioned that removal of the electron-induced surface modified layer may be achieved by exposing it to electromagnetic radiation of specific wavelength. This aspect of the invention allows thickness and density gradual controlling of the electron-induced modified layer using variation of electron beam parameters (current density, electron energy, time of exposition) and combination of the later with electromagnetic radiation of specific wavelength. Both kinds of treatments provide full reversibility of the electron-modified properties.

The electron irradiation of samples was performed in a vacuum (10⁻⁶ Torr) at room temperature, using invariable electron energy when the later is co-adapted to the irradiated material properties, providing defect-free irradiation, and it was chosen as Eₚ<1000 eV. The electron dose in the below experiments was varied in a wide range of incident electron charge to achieve the desired effect of layer fabrication and to demonstrate that thickness and density of the electron-induced layer may be varied. The results of the surface modification were characterized by topography measurements using atomic force microscopy (AFM) (Multimode, DI, USA). Additionally, high-frequency capacitance-voltage (C-V) data was recorded at a frequency of 100 kHz (HP 4284A, Hewlett-Packard, Tokyo, Japan) as a function of the biasing voltage on Al/organic layer/SiO₂/Si devices.

FIG. 48A illustrates contact mode AFM surface topography image of the patterned SiO₂ surface induced by electron irradiation with electron energy Eₚ=1000 eV and exposed electron dose of Q=50 μC/cm². One may clearly recognize the pattern in the top view image which was fabricated by scanning the SiO₂ surface by focused electron beam. In FIG. 48A, the surface protrusions are white and depressions are black. FIG. 48B demonstrates features as small as 0.7-0.8 nm that are visible in the 100 nm period gratings. It should be noted that features' height were varied, ranging from 0.4 to 1.5 nm for Q˜10 and 150 μC/cm², respectively. In addition, the elipsometery measurements indicated an increase in the film thickness with increasing the electron doses.

FIG. 49 illustrates the AFM image of high-resolution electron-patterned SiO₂ surface with features of about 10 nm widths and 0.6 nm heights. These high-resolution AFM measurements were performed in contact mode using an ultrasharp Si tip with 5 nm radius of curvature.

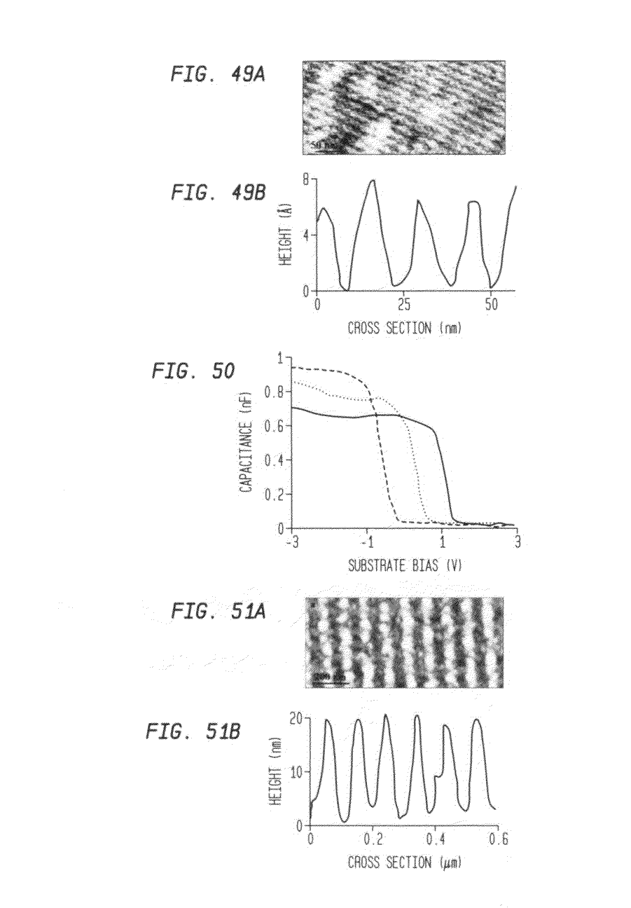

Measured characteristics of SiO₂/Si devices with and without an electron modified layer tailored by electron beam irradiation (Eₚ=1000 eV) are shown in FIG. 50. The accumulation capacitance, the capacitance for negative biases (maximum capacitance, Cₘₐₓ), is lower in the Al/modified layer/SiO₂/Si devices with respect to the no-molecule Al/SiO₂/Si control devices. The combined dielectric stack of the modified monolayer on SiO₂ is a thicker total dielectric giving rise to the observed lower accumulation capacitance. The dielectric thickness of the tailored organic layer, t_{org}, can be extracted from the C-V measurements by considering a very simple model of two serial capacitances (C_{org} and Cₒₓ for organic and oxide layers, respectively) for the bilayer insulator:

$${C}_{max} = \frac{{C}_{org} \cdot {C}_{ox}}{{C}_{org} + {C}_{ox}} .$$

with C_{org} and Cₒₓ found by presuming a parallel plate capacitance model, viz.:

$${C}_{org} = \frac{{ɛ}_{org} {ɛ}_{0} A}{{t}_{org}} and {C}_{ox} = \frac{{ɛ}_{ox} {ɛ}_{0} A}{{t}_{ox}} ,$$

where A is the aluminum electrode area, tₒₓ is the thickness of the SiO₂ layer, ε₀ is the free space permittivity, ε_{org} and εₒₓ are the organic and oxide layer permittivity, respectively. Consequently, assuming ε_{org}=2.5 the organic layer thickness is t_{org}=0.4 and 1.6 nm for Q˜10 and 150 μC/cm², respectively. These values are is in relatively good agreement with layers heights found by AFM and ellipsometry measurements. A significant shift of the threshold voltage was observed for electron irradiated samples (FIG. 50).

Similarly patterned samples (FIGS. 48 and 50) were also exposed to UV illumination for varying times, and the progress of the reaction was followed by AFM. AFM measurements of the irradiated SiO₂ surface showed complete disappearance of the generated by electron beam layer during less than 3 min. using illumination performed by a non-filtered light of 185-2000 nm (Hamamatsu UV spot light source equipped with 200 W Hg—Xe lamp). The observed light-stimulated film removal reverses the electron-irradiated sample to the initial state.

In such a way, the developed method for formation of surface modified layers allows to fabricate thickness-controllable encapsulation and/or protective layers of different chemical origins, which depend on physico-chemical properties of the sample surface and/or irradiation environment, for different applications.

Chemical Stability and Etching Technology.

Chemical stability is defined as a “resistance to change”. It is a key technological parameter in any modern microelectronic, information and optical technology in fabrication of integrated VLSI circuits, multilayer dielectric and semiconductor structures, thin film transistors deposition for flat panel displays and smart windows, antireflection coatings, etc.

The experiments were carried out on 600 nm thick thermal SiO₂ film grown on top of a p-type Si substrate of resistivity in the range from 11 to 17 Ωcm. The electron irradiation of SiO₂ samples was performed in vacuum 10⁻⁶ Torr at room temperature, using invariable energy of the incident electrons Eₚ=1000 eV by the use of scanning electron beam. The electron irradiation dose Q was varied up to 150 μC/cm². Scanning the sample surface by electron beam allowed performing electron patterning on the irradiated surface.

The studied SiO₂ samples were specially irradiated (patterned), using high-resolution Si shadow mask. The surface's chemical resistivity (stability) was characterized by dipping, into various etchants. HF in various concentrations was used for the SiO₂ etching. FIG. 51 shows a structure of patterned SiO₂ surface irradiated by electron beam (Eₚ=1000 eV, Q=100 μC/cm²) followed by 10 sec etching in 6:1 HF solution. The electron irradiated regions show much higher resistance to the used chemical etcher that is much higher chemical stability while non-irradiated region were strongly etched. The etch depth is about ˜20 nm (FIG. 51B), however the better results were achieved in 100:1 buffered HF. The observed trenches of 50 nm width are homogeneous and are shaped as cylinder segments with a constant cross section (FIG. 51B).

The electron-induced chemical stability modification method of the invention allows fabricating high-resolution two- and three-dimension nanostructure morphologies made on the surface of used materials. Electron beam writing is used to locally modified materials surface without using SAMs or/and photoresists, etc.

The method is particularly useful in low-energy (at Eₚ˜1000 eV or lower) lithography applications. The electron irradiation strongly increases the chemical resistance (chemical stability) due to formation of protective electron-modified layer. The proper choice of the etching chemicals may provide pronounced patterns transfer.

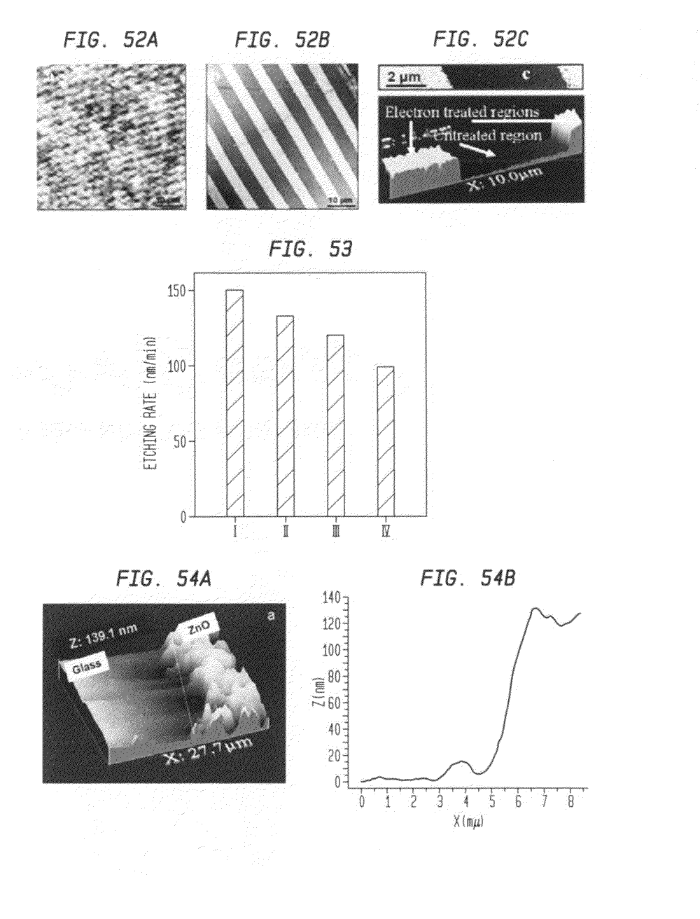

It should be noted that similar results of formation of chemically-resistant state of the material surface, provided by generation of electron-induced modified surface layer, were obtained on SiO₂ surface using electron irradiation with electron energies in the range up being equal to or Eₚ<1000 eV, when the electron incident beam parameters were co-adapted to irradiation conditions and samples properties, such as secondary and backscattering electron coefficients, traps structure in vicinity of the sample surface, etc. FIG. 52A illustrates a structure of SiO₂ surface patterned by using electron irradiation with electron flux (Eₚ=100 eV, Q=50 μC/cm²) followed by a 10-sec etch in 6:1 HF solution. The electron irradiation was performed through a shadow mask. The observable chemically etched trenches of 10 μm in width were homogeneous and shaped as cylinderical segments with a constant cross section (FIG. 52B).

The increased interest in transparent conductive thin films for optoelectronic devices such as, solar cells, liquid crystal displays, pressure sensor, gas sensor, optical memory, electro-optic displays, heat mirrors and multilayer photothermal conversion systems leads to an optimization of the electro-optical properties of these films.

ZnO has emerged as one of the most widely-used transparent conductive oxides due to its electro-optical properties, high electro-chemical stability, large band gap, abundance in nature and absence of toxicity. The properties exhibited by the ZnO thin films depend on the non-stoichiometry of the films resulting from the presence of oxygen vacancies and interstitial zinc. However, the electrical behavior of ZnO thin films could be improved by replacing Zn²⁺ atoms by elements with higher valence such as In³⁺, Al³⁺and Ga³⁺. The electro-optical properties are generally dependent on the deposition and post-deposition conditions, because these properties change significantly with the absorption and desorption of oxygen that occurs during these processes.

Indium tin oxide (ITO, In₂O₅:Sn₂O₃ thin films) is an optically transparent semiconductor oxide material that finds extensive applications in liquid crystal displays (LCD), photovoltaic cells, touch screen displays, electro-chromic smart windows and more. Compared to ITO-transparent conductive films, ZnO is chemically stable in hydrogen plasma. Due to this property, amorphous silicon can be deposited on ZnO in order to produce solar cells. Low chemical stability (high etching rate) in oxalic acids and NaOH base is a critical factor for ZnO thin film oxide materials that prevents their application in optical information devices (LCD monitor and displays) and smart windows technology.

In order to improve resistance to chemical etching, the method of the invention was applied so as to modify the electron-induced chemical stability of the ZnO-films. The samples were exposed to electron irradiation with electron energy of Eₚ=1000 eV.

Used in ZnO deposition technology protocols, oxalic acid (C₂H₂O₄) and NaOH base solutions in various concentrations were applied to the ZnO-film coated glass according to the etching procedure. The chemical etching rate of the untreated and electron irradiated samples in 0.1M oxalic acid for 60 sec is shown in FIG. 53. The highest etching rate of 150 nm/min corresponds to untreated sample, whilst the lowest etching rate of 100 nm/min corresponds to the electron irradiated sample with high electron dose Q=360 μC/cm² giving improvement of the chemical stability by 1.5 times.

Similar results were observed for ZnO samples etched in 10% NaOH base solution. FIG. 54 shows the difference between etching rate (after 60 sec in 10% NaOH) of untreated and electron irradiated parts of an initially patterned ZnO sample. The sample was patterned using specially designed Si-hard shadow which divides the sample into two parts, untreated and electron irradiated (Eₚ=1000 eV) by electron beam under high irradiation dose of Q=360 μC/cm².

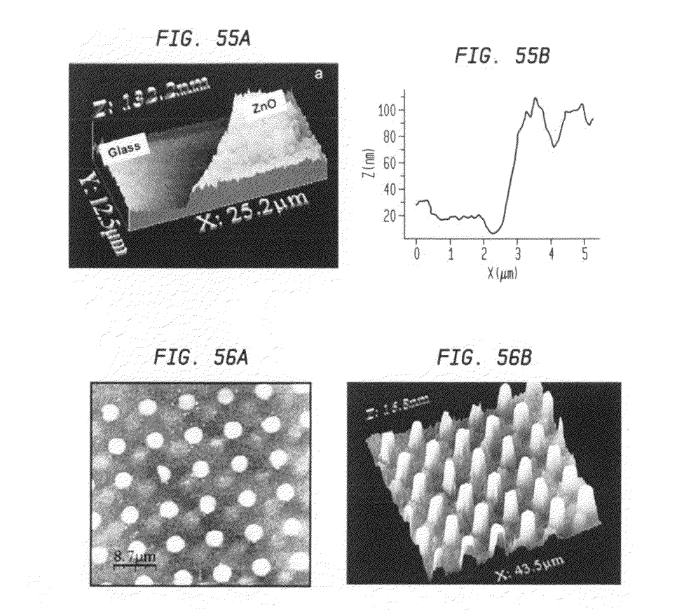

The better results, more controllable etching process, were achieved by a multistep process, where each step included electron irradiation followed by chemical etching (as shown in FIG. 55). The etching-non-etching contrast on ZnO surface fabricated by two-step process, which included irradiation by electrons with energy of about Eₚ=1000 eV (incident charge of Q=360 μC/cm²) and 30 sec etching in 0.1M oxalic acid, was decreased by 5 times to 30 nm/min for electron irradiated sample compared to 150 nm/min for untreated sample (FIG. 53).

Another advantage of the method of the invention is the high-resolution patterning and the ability to fabricate unlimitedly large and micro/nano-patterned templates for formation of three dimensional-patterned arrays using electron irradiation either through a shadow mask or scanning electron beam followed by chemical etching (FIG. 56).

Electrical resistivity (Four Point Probe Resistivity Tester S-301-6) and optical transparency measurements were performed on untreated and electron irradiated ZnO-coated samples. No significant changes in conductivity (Table 7) and optical transparency (FIG. 57) were found after low and high dose electron irradiation.

TABLE 7
Resistivity measurements performed by four point probe tester
(accuracy of 0.5%) on low (Q~100 μC/cm²) and high dose
(Q~400 μC/cm²) electron beam irradiated ZnO surface after
exposure by electrons with energy Eₚ = 1000 eV.

| | | Average | |
|---|---|---|---|
| | Resistance | Conductivity | Ideality |
| | Rₛ [Ω] | σ [1/Ω cm] | Factor Kₐ |
| Untreated | 7-9 | 2.1 · 10³ | 3.2 |
| E-beam treated (low dose) | 5-7 | 2.5 · 10³ | 3.5 |
| E-beam treated (high dose) | 6-8 | 2.3 · 10³ | 3.2 |

In such a way the method of the invention allows for a gradual improvement in chemical resistivity (stability) of the ZnO-coated glass samples, without generating or modifying bulk and surface defects, variation of optical and electrical resistivity, phase state of materials.

The electron-induced chemical modification method of the invention, as applied to ZnO oxide materials, showed significant improvement of chemical resistivity (stability) both in acid and base.

It should be noted that the method of the invention was also applied on other solid materials, showing significant improvement of chemical resistivity (stability) both in acid and base. This method was successfully applied by the inventors of the present invention to materials, such as glass, copper thin and thick film, and others, using different etching solutions.

Hygroscopic Properties

Hygroscopicity is the ability of a substance to attract liquid molecules from the surrounding environment through either absorption or adsorption. From a technological point of view, the hygroscopicity is also characterized as the capacity of a material to react to the moisture content of the air by absorbing or releasing liquid vapor. Hygroscopicity is a key property of any material, physical process and/or technology, relating to fine material particles in micro-nanoscale-size, such as aerosols and powders, as well as soluble crystalline and porous materials including some sort of porous ceramics, amorphous materials of different origin which are the basis for a wide range of modern development and production in pharmaceutics, chemical and construction material industries, biotechnology, food engineering, military purposes, etc.

Calcium acetate (calcium ethanoate is the systematic IUPAC name) was chosen as a representative of powder materials. Calcium acetate is of the formula Ca(C₂H₃O₂)₂. The anhydrous form is very hygroscopic; therefore the monohydrate Ca(CH₃COO)₂.H₂O is the common form. Calcium acetate is a food additive, mainly in candy products, or as a preservative in bread products.

The method of the invention was applied to calcium acetate fine powder. FIG. 58 demonstrates a modification in the hygroscopic properties, e.g. behavior of the water droplets deposited of the calcium acetate powder. In the experiments, the powder was preliminary distributed over a smooth metallic surface. It may be clearly observed that immediately after deposition of water droplets on the untreated calcium acetate powder, it begins to absorb water and shows a pronounced wet granulation process (FIG. 58A), where de-liquescenced powder creates large “rocks” of the hydrate of the acetate. In the case of preliminary electron irradiation (Eₚ=500 eV, Q=300 μC/cm²), the hygroscopic strongly changes: FIG. 58B shows water droplets located on the electron irradiated powder without visible process of the material granulation.

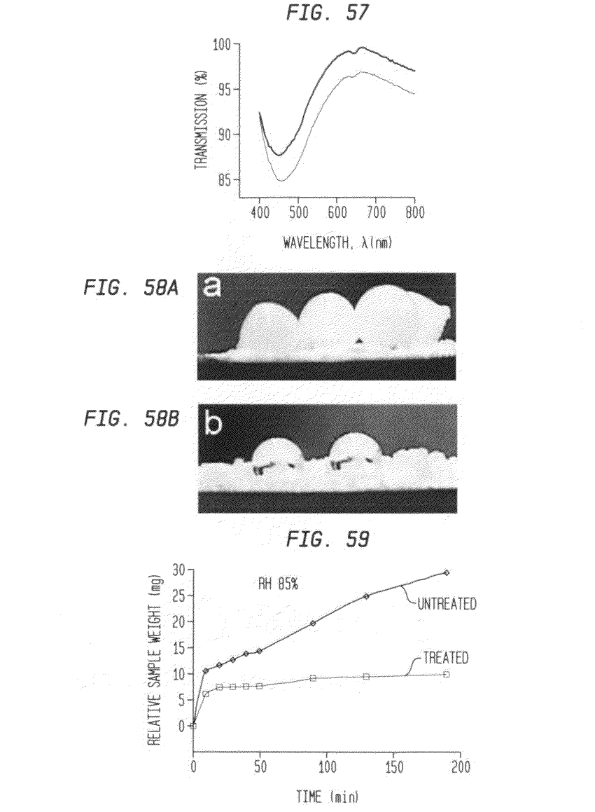

Another experiment was conducted with calcium acetate powder in a controllable humidity environment. Saturated salt solution (KCl) was used to create a specific relative humidity (RH) (85%) within a closed chamber. Relative weight variation of the calcium acetate powder is plotted versus time (FIG. 59), when the initial powder weight was 1 gram. The powder was irradiated using electron beam (Eₚ=500 eV, Q=300 μC/cm²). FIG. 59 shows a pronounced difference in the hygroscopicity of untreated and electron-irradiated acetate powder. In the 200 min of humidity test the weight of untreated calcium acetate powder exceeded the irradiated powder by 6 times.

It should be noted that the method of the invention was also applied on other powder and/or porous materials, showing significant modification in the hygroscopic and/or wettability properties. This method was successfully applied by the inventors of the present invention to powder and/or porous materials, such as ZnO nanopowder, paper, calcium phosphate, and others.

The major technical difficulties recognized by the art concerning existing technologies have to do with the ability to control agglomeration of newly formed particles. Agglomeration may be a problem, especially where very fine powders are produced. The method of surface modification allows modifying the surface energy of the powder in such away that oxidation and agglomeration is prevented by formation of electron-induced encapsulation layer.

Those skilled in the art that various modifications and changes can be applied to the embodiments of the invention as hereinbefore described without departing from its scope defined in and by the appended claims.

1. A method for modifying properties of a solid material, the method comprising irradiating at least a region of the material by an electron beam and controlling at least one parameter of said radiation, in accordance with said material, in order to modify a surface property of the material within said at least region thereof, by inducing or varying a surface property without affecting any structural or phase state modification of the material within said at least one region.

2. A method of claim 1, wherein said modification of the surface property is reversible.

3. A method of claim 1, wherein the electron beam is a low energy beam, typically the energy substantially not exceeding 1000 eV.

4. A method according to claim 1, comprising applying electromagnetic radiation to said at least one region of the material while being irradiated by the electron beam.

5. A method according to claim 4, wherein said electromagnetic radiation is at least one of light and heat.

6. A method according to claim 1, wherein said at least one parameter of the irradiation comprises at least one of direction of electron beam propagation, current density of electron beam, electron energy, and duration (dose) of irradiation.

7. A method according to claim 4, wherein at least one parameter of the electromagnetic radiation, selected from wavelength, intensity, polarization, duration of radiation and/or profile, is adjusted in accordance with the material being modified and its surface property to be varied.

8. A method of claim 1, wherein the induced variation of the surface property is reversed by applying electromagnetic radiation to the surface.

9. A method of claim 1, comprising applying said electron beam radiation to the selected regions of the material, thereby creating a pattern formed by an array of spaced-apart surface regions with modified property.

10. A method of claim 9, comprising controlling attachment or non-attachment of a foreign material to said material with the created pattern, where said foreign material is attached to said surface-modified regions, while substantially not attachable to the spaces between said regions.

11. A method according to claim 1, wherein said modifying of the surface property of the material within said at least region thereof comprises switching or gradual tuning of at least one of affinity, wettability, adhesion, adsorption, hygroscopicity, bonding, friction, encapsulation, and agglomeration.

12. A method according to claim 11, wherein said modifying of the surface property of the material within said at least region thereof comprises modifying the affinity of the surface within said at least selected region to a certain foreign material, thereby enabling attachment of a certain foreign material to said at least selected region due to the modified affinity thereof.

13. A method of claim 12, wherein said pattern is a pattern of the spaced-apart regions of a certain surface affinity different from that in the spaces between said regions.

14. A method of claim 13, wherein said pattern is one-, two- or three-dimensional pattern.

15. A method of claim 14, wherein said regions have the same or different geometries.

16. A method of claim 12, wherein said foreign material is a biological material.

17. A method according to claim 16, wherein said biological material is selected from biocells, biological molecules such as nucleotides, polypeptides, small organic compounds, blood components, bacteria, and fungi.

18. A method according to claim 1, comprising applying a certain second material to the modified region of the surface of the first material, thereby either allowing or preventing crystallization of said certain second material on the modified surface region of the first material.

19. A method according to claim 1, wherein said modifying the surface property of the material within said at least region thereof comprises converting said region from an initial hydrophilic state into a hydrophobic state or vice versa, enabling the reversible conversion.

20. A method according to claim 1, wherein modifying the surface property of the material within said at least region thereof comprises effecting attachment/non-attachment of first and second solid materials to or from each other, the method comprising applying irradiation to at least one region of either one or both of the first and second solid materials using an electron beam to modify a surface property of said at least one region within the respective material, thereby providing attachment/non-attachment of the first and second materials within said at least region of the modified surface charge and/or surface energy property.

21. A method according to claim 20, wherein said second material is to be attached to the first material at least within the selected surface region thereof, while in the initial, non-modified state of the first and/or second material within said at least one surface region, such attachment cannot be achieved.

22. A method according to claim 20, wherein the first and second materials in the non-modified state are attached to one another at least within a selected surface region at the interface between them, while modifying said at least one surface region allows non-attachment of the first and second materials.

23. A method according to claim 1, the method comprising applying electron irradiation with at least one controllable parameter to an array of spaced-apart surface regions of a solid material so as to create the array of the spaced-apart surface regions having modified surface-related property; and applying a material removal process to said material thereby removing the material from either said modified surface regions or the spaces between them, while substantially leaving the material within respectively the spaces or said regions.

24. A method according to claim 1, wherein said material is the surface of an implant, biosensor, biomedical device, contact lenses, glass or paper.

25. A method according to claim 1, wherein said irradiated material includes at least one of a biomimetic material, a biomaterial, a Si-based material, a dielectric crystalline or amorphous material, a metal, an oxide, a ceramic material, and powder materials.

26. A method according to claim 25, wherein said biomimetic material includes at least one of a Hydroxyapatite (HAP) bioceramic, a HAP synthesized ceramic, a human implant with a HAP coating and related Ca, P-materials, a sea shell, and a hydrogel.

27. A method according to claim 25, wherein said Si-based material includes at least one of P- and N-type Si, Si₃N₄, SiO₂, Si-nanodots embedded into SiO₂ matrices, fused silica and glass.

28. A method according to claim 25, wherein said dielectric, amorphous material includes at least one of, polymers, ferroelectrics, paper and crystalline materials such as mica, and alumina,

29. A method according to claim 25, wherein said metal includes at least one of Al, Zn, Ag, Co, Pd, Cu and Ti.

30. A method according to claim 29, wherein said metal is coated by native oxides.

31. A method for modifying a surface of a solid material, the method comprising irradiating at least a region of the material by an electron beam and controlling at least one parameter of said radiation, in accordance with said material, in order to induce or modify hygroscopicity of the material within said at least region thereof, by inducing or varying a surface property of the material without affecting any structural or phase state modification of the material within said at least one region.

32. A device for modifying a property of a solid material, the device comprising an electron beam source configured and operable to generate a low energy electron beam for irradiating at least a selected region of the material, and a control unit for operating said source to control at least one parameter of said electron beam in accordance with said material so as to induce or vary a surface potential and/or surface energy within said at least selected region and thereby induce a change in the surface property while avoiding any structural or phase state modification of the material within said at least selected region, the device being therefore configured and operable as a modifying device for modifying a surface property of at least the selected region, in a manner enabling a change of the surface property.

33. A device according to claim 32, further including electromagnetic radiation source applied to at least one surface region of a solid material while being irradiated by the low energy electron beam, enabling a reversible change of the surface property.

34. A device according to claim 32, for use in modifying the properties of an implant.

35. A biosensor system comprising the device of claim 32, and adapted to identify a second material by its ability to attach or non-attach to said at least one region of the first material to which the irradiation has been applied.

36. A biosensor system according to claim 35, wherein said first material is a biomaterial.

37. A solid material having at least one surface region or a pattern of spaced-apart surface regions of a surface property different from surrounding regions of said material.

38. A solid material according to claim 37, being at least one of a biomimetic material, a biomaterial, a Si-based material, a dielectric crystalline or amorphous material, a metal, an oxide, a ceramic material, and powder materials.

39. A biosensor device comprising the solid material of claim 37, the device being adapted to identify a predetermined material by its ability or non-ability to couple to said at least one surface region of the predetermined surface property.

40. A lens made of the solid material of claim 37 having said at least one surface region of the surface property different from the surrounding regions of the lens material, the lens being thereby protected from fogging within said at least one surface region.
